(19) United States
(12) Patent Application Publication
(10) Pub. No.: US 2013/0034789 A1
(43) Pub. Date: Feb. 7, 2013

(54) BIPOLAR PLATE ASSEMBLY FOR USE IN A FUEL CELL

(71) Applicants: Thomas Pavlik, North Palm Beach, FL (US); James Braun, Lake Worth, FL (US); Matthew Graham, West Palm Beach, FL (US)

(72) Inventors: Thomas Pavlik, North Palm Beach, FL (US); James Braun, Lake Worth, FL (US); Matthew Graham, West Palm Beach, FL (US)

(73) Assignee: ENERFUEL, INC., West Palm Beach, FL (US)

(21) Appl. No.: 13/566,406

(22) Filed: Aug. 3, 2012

Related U.S. Application Data
(60) Provisional application No. 61/515,335, filed on Aug. 5, 2011.
(60) Provisional application No. 61/523,975, filed on Aug. 16, 2011.

(51) Int. Cl. H01M 8/04; H01M 4/64

(52) U.S. Cl. 429/434; 429/518

(57) ABSTRACT

A bipolar plate assembly includes a first material and a second material. The second material has an in-plane thermal conductivity greater than the first material. The second material has a width and a thickness. A ratio of the width to the thickness of the second material is between 50 and 400.

### CROSS REFERENCE TO RELATED APPLICATIONS

This application claims the benefit of U.S. Provisional Application No. 61/515,335 filed Aug. 5, 2011 and U.S. Provisional Application No. 61/523,975 filed Aug. 16, 2011. Both of these applications are hereby incorporated by reference in their entireties.

### FIELD

The field of this disclosure relates generally to fuel cells and more specifically to bipolar plate assemblies for use in a fuel cell.

### BACKGROUND

Some known fuel cells comprise a fuel cell stack having a plurality of bipolar plates interleaved with suitable electrolytes (e.g., membrane electrode assemblies (MEA)). Suitable catalysts are disposed between each of the bipolar plates and the respective electrolyte to define anodes and cathodes. During the operation of the fuel cell stack, hydrogen is oxidized which produces electricity. More specifically, the hydrogen is split into positive hydrogen ions and negative charged electrons. The electrolyte allows the positive hydrogen ions to pass through to the cathode. The negative charged electrons, which are unable to pass through the electrolyte, travel along an external pathway to the cathode thereby forming an electrical circuit.

At the cathode heat is released as the negative charged electrons are combined with the positive hydrogen ions to form water. During this process, the bipolar plates act as current conductors between cells, provide conduits for introducing the reactants (e.g., hydrogen, oxygen) into the cells, distribute the reactants throughout the cell, maintain the reactants separate from cell anodes and cathodes, and provide discharge conduits for the water, unused reactants, and any other by-products to exit the system.

In addition to producing electricity, the chemical reactions that take place between the reactants in the fuel cell produce heat. Excess heat needs to be removed for optimum operation of the fuel cell. Typically, excess heat is removed from fuel cells by introducing a cooling circuit between each of the fuel cells in a stack. Liquid coolant is pumped from an external source through the cooling circuit. As the liquid coolant passes the fuel cells, the coolant absorbs heat thereby cooling the fuel cells. After the liquid coolant leaves the fuel cells, it is passed through a heat exchanger, which transfers the heat away from the liquid coolant. In a closed-loop system, the liquid coolant is then pumped back through the cooling circuit to absorb more heat from the fuel cells.

Heat can also be removed from the fuel cells at the edges of the bipolar plates by convection or conduction. However, removal of heat from the edges of the bipolar plates can present challenges. The area available for heat exchange and the thermal conductivity of the plate material influence the rate at which heat can be removed. Thus, convection and conduction removal are often unable to adequately remove excess heat from the fuel cells.

In addition, fuel cells often operate most efficiently at a fairly high, target temperature. Thus, it is important that the cooling system is capable of regulating the fuel cell at or near the target temperature.

Various attempts have been made to improve cooling and temperature regulation of fuel cells. Nevertheless, there still remains a strong need for a reliable, efficient solution for cooling and regulating the temperature of fuel cells.

### SUMMARY

In one aspect, a bipolar plate assembly generally comprises a first material and a second material. The second material has an in-plane thermal conductivity greater than the first material. The second material has a width and a thickness. A ratio of the width to the thickness of the second material is between 50 and 400.

In another aspect, a bipolar plate assembly has a longitudinal axis and a transverse axis. The assembly generally comprises at least one bipolar plate being formed from a first material and at least one insert member formed from a second material. The second material has an in-plane thermal conductivity greater than the first material and adapted to conduct heat away from the longitudinal axis of the bipolar plate assembly.

In yet another aspect, a bipolar plate assembly generally comprises at least one bipolar plate formed from a first material. The first material has a thermal conductivity less than 60 W/mK. At least one insert member is formed from a second material. The second material has an in-plane thermal conductivity greater than greater than 100 W/mK.

### BRIEF DESCRIPTION OF THE DRAWINGS

FIG. 1 is a perspective of one embodiment of a bipolar plate assembly for use in a fuel cell.

FIG. 2 is a plan view of a front face of the bipolar plate assembly of FIG. 1.

FIG. 3 is a plan view of a back face of the bipolar plate assembly.

FIG. 4 is a side elevation view of the bipolar plate assembly.

FIG. 5 is an end view of the bipolar plate assembly.

FIG. 6 is an exploded view of the bipolar plate assembly.

FIG. 7 is a perspective of an insert member of the bipolar plate assembly.

FIG. 8 is an enlarged portion of insert member of FIG. 7 illustrating a slot cut into the insert member.

FIG. 9 is an enlarged portion of the insert member similar to FIG. 8 but illustrating an edge of the slot being encapsulated.

FIG. 10 is a fragmentary perspective of one bipolar plate of the bipolar plate assembly, the bipolar plate having adhesive applied to an inner surface thereof.

FIG. 11 is a perspective of a second embodiment of a bipolar plate assembly for use in a fuel cell.

FIG. 12 is an exploded view of the bipolar plate assembly of FIG. 11.

FIG. 13 in an enlarged fragmentary end view of the bipolar plate assembly of FIG. 11 illustrating a pocket formed in the in the bipolar plate assembly.

FIG. 14 is a perspective of a third embodiment of a bipolar plate assembly for use in a fuel cell.

FIG. 15 is a plan view of a front face of the bipolar plate assembly of FIG. 14.

FIG. 16 is a plan view of a back face of the bipolar plate assembly.

FIG. 17 is a side elevation view of the bipolar plate assembly.

FIG. 18 is an end view of the bipolar plate assembly.

FIG. 19 is an exploded view of the bipolar plate assembly.

FIG. 20 is a perspective of an insert member of the bipolar plate assembly of FIG. 14.

FIG. 21 is a fragmentary perspective of one bipolar plate of the bipolar plate assembly, the bipolar plate having a recess defined in an inner surface thereof.

FIG. 22 is a fragmentary perspective of the bipolar plate of FIG. 21 having adhesive applied to its inner surface.

FIG. 23 is a fragmentary perspective of the bipolar plate of FIG. 21 having a non-adhesive coating applied to its inner surface.

FIG. 24 is a fragmentary perspective similar to FIG. 23 but showing the insert member receiving within the recess.

FIG. 25 is a cross-section taken along line 25-25 of FIG. 15.

FIG. 26 is a cross-section similar to FIG. 25 but illustrating another configuration of the engagement between bipolar plates of the bipolar plate assembly.

FIG. 27 is a cross-section similar to FIG. 25 but illustrating another configuration of the engagement between bipolar plates of the bipolar plate assembly.

FIG. 28 is a cross-section similar to FIG. 24 but illustrating a configuration of the bipolar plate assembly having two insert members.

FIG. 29 is a cross-section illustrating a configuration of the bipolar plate assembly having four insert members.

FIG. 30 is a cross-section similar to FIG. 28 but illustrating an engagement member disposed between the two insert members.

FIG. 31 is a fragmentary exploded view of the bipolar plate assembly illustrated in FIG. 30.

FIG. 32 is an enlarged, fragmentary view of the engagement member of FIG. 30.

FIG. 33 is a cross-section similar to FIG. 28 but illustrating another embodiment of an engagement member disposed between the two insert members.

FIG. 34 is an enlarged, fragmentary view of the engagement member of FIG. 33.

FIG. 35 is a cross-section similar to FIG. 28 but illustrating a conductive filler disposed between the two insert members and the insert members and respective bipolar plate.

FIG. 36 is a cross-section similar to FIG. 25 but illustrating an elastomeric layer disposed between the bipolar plates of the bipolar plate assembly.

FIG. 37 is a cross-section similar to FIG. 25 but illustrating a shim disposed between bipolar plates of the bipolar plate assembly.

FIG. 38 is a cross-section of a compressible material suitable for use as an insert member of the bipolar plate assembly, the compressible material being seen in an uncompressed configuration.

FIG. 39 is a cross-section illustrating the compressible material being used as an insert member of a bipolar plate assembly, the compressible material being seen in a compressed configuration.

FIG. 40 is a perspective of a fourth embodiment of a bipolar plate assembly for use in a fuel cell.

FIG. 41 is a plan view of a front face of the bipolar plate assembly of FIG. 40.

FIG. 42 is a plan view of a back face of the bipolar plate assembly.

FIG. 43 is a side elevation view of the bipolar plate assembly.

FIG. 44 is an end view of the bipolar plate assembly.

FIG. 45 is an exploded view of the bipolar plate assembly.

FIG. 46 is a perspective of a fifth embodiment of a bipolar plate assembly for use in a fuel cell.

FIG. 47 is a plan view of a front face of the bipolar plate assembly of FIG. 46.

FIG. 48 is a plan view of a back face of the bipolar plate assembly.

FIG. 49 is a side elevation view of the bipolar plate assembly.

FIG. 50 is an end view of the bipolar plate assembly.

FIG. 51 is an exploded view of the bipolar plate assembly.

FIGS. 52-54 illustrate the results of a one-quarter plate computational thermal analysis of the bipolar plate assembly illustrated in FIGS. 14-19.

FIGS. 55-57 illustrate the results of a one-quarter plate computational thermal analysis of the bipolar plate assembly illustrated in FIGS. 40-45.

FIGS. 58 and 59 illustrate the results of a one-quarter plate computational thermal analysis of the bipolar plate assembly illustrated in FIGS. 46-51.

FIGS. 60 and 61 illustrate the results of a one-quarter plate computational thermal analysis conducted on a conventional monolithic bipolar plate.

FIG. 62 graphically provides data collected during the operation of a 1.25 kW 36-cell fuel cell stack with external oil cooling having a plurality (i.e., 36) of the bipolar plate assemblies illustrated in FIGS. 1-6.

### DETAILED DESCRIPTION OF THE DRAWINGS

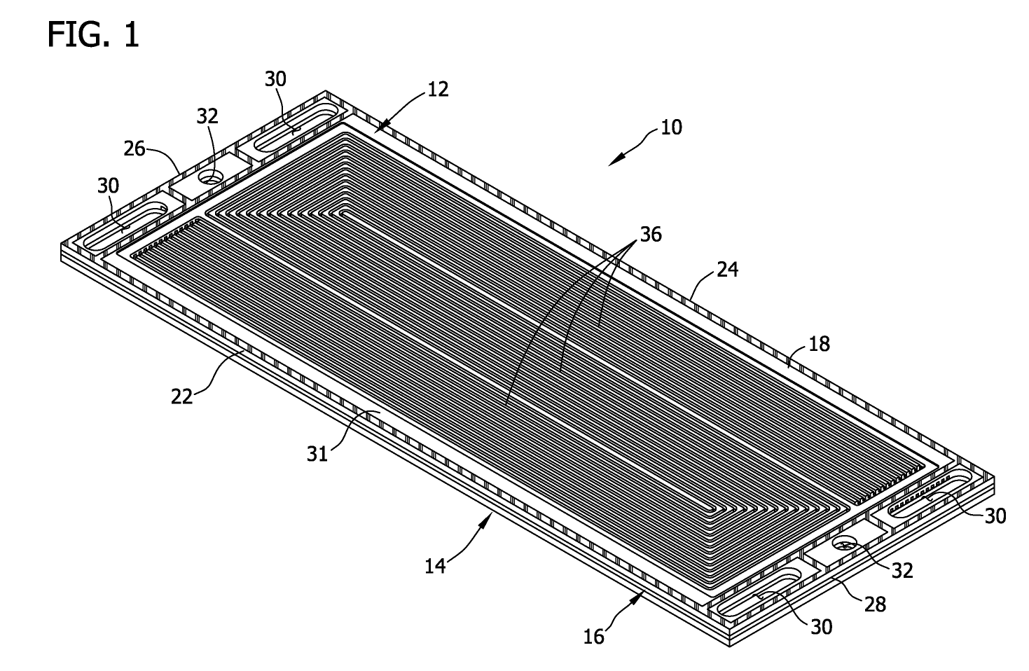

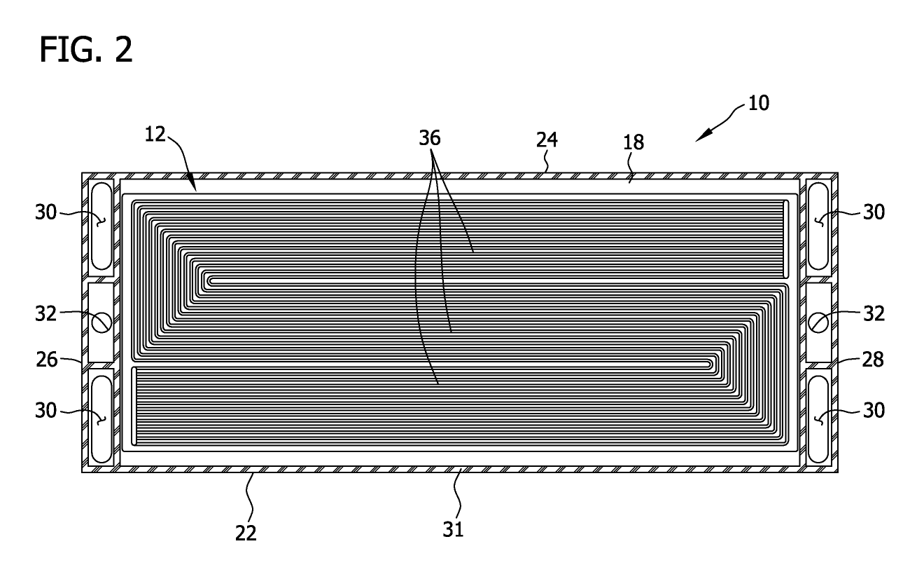

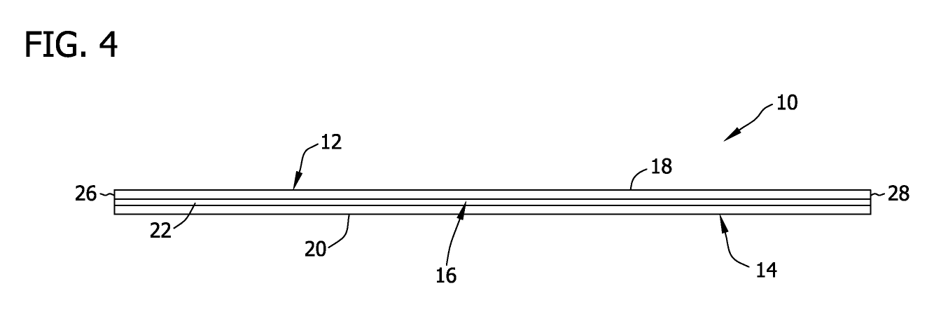

With reference now to the drawings and specifically to FIGS. 1-6, one embodiment of a bipolar plate assembly for use in a fuel cell is generally indicated at 10. As illustrated, the bipolar plate assembly 10 comprises a first bipolar plate 12, a second bipolar plate 14, and at least one insert member 16 disposed between the first and second bipolar plates. The first and second bipolar plates 12, 14 and the insert member 16 are indicated generally by their respective reference numbers in the accompany drawings. In the illustrated embodiment, the bipolar plate assembly 10 has a generally rectangular box shape (i.e., a right cuboid). Accordingly, the illustrated bipolar plate assembly 10 has six generally rectangular faces. More specifically, the bipolar plate assembly 10 has a pair of opposed primary faces (i.e., a front face 18 and a back face 20), a pair of longitudinal side faces 22, 24, and a pair of lateral side faces 26, 28. It is understood, however, that the bipolar plate assembly 10 can have any suitable shape.

The bipolar plate assembly 10 includes four apertures 30 for allowing fluid (gas and/or liquid) to pass through the bipolar plate assembly. As seen in FIGS. 1-3, each of the apertures 30 extends through the primary faces 18, 20 adjacent respective corners of the bipolar plate assembly 10. It is understood that the bipolar plate assembly 10 can have more or fewer apertures 30 and that the apertures can be disposed at locations different than those illustrated in FIGS. 1-3. In the illustrated embodiment, each of the apertures 30 has a generally racetrack shape but it is understood that the apertures can have any suitable shape (i.e., circle, rectangular, elliptical). The bipolar plate assembly 10 also includes a pair of generally circular openings 32 for allowing a dowel (or tie rod) to extend through the bipolar plate assembly. While the openings 32 in the illustrated embodiment are generally circular, it is understood that the openings 32 can be any suitable shape (i.e., square, elliptical, triangular). It is also understood that in some embodiments of the bipolar plate assembly 10, the openings 32 can be omitted.

Each of the primary faces 18, 20 of the bipolar plate assembly 10 has a plurality of channels 36 for distributing fluid across the respective primary face. In the illustrated embodiment, the channels 36 on the front primary face 18 are fluidly connected to two of the apertures 30 and the channels 36 on the back primary face 20 are fluidly connected to the other two apertures 30. As a result, one of the apertures 30 acts as an inlet for the channels 36 and the other aperture in fluid communication with the same channel acts as an outlet. The illustrated channels 36 define a serpentine pathway for the fluid as the fluid flows from the aperture 30 defining the inlet to the aperture defining the respective outlet. It is understood that the channels 36 can have different configurations than the configuration illustrated in FIGS. 1-3. For example, the channels 36 can define a generally linear pathway as the fluid flows from the aperture 30 defining the inlet to the aperture defining the respective outlet. In such an embodiment, the channels 36 can extend longitudinally, laterally or diagonally (i.e., at angles relative to the longitudinal and lateral axes of the bipolar plate assembly 10). It is understood that the primary faces 18, 20 can have more or fewer channels than those illustrated in the accompanying drawings. It is also understood that the primary faces 18, 20 can have a different number of channels. That is, for example, the front primary face 18 can have more or fewer channels than the back primary face 20.

With reference still to FIGS. 1-3, the first bipolar plate 12 is held in assembly with the second bipolar plate 14 and the insert member 16 with the insert member being sandwiched between the first and second bipolar plates. In one suitable embodiment, the first bipolar plate 12, second bipolar plate 14, and/or insert member 16 are bonded together (e.g., adhesive bonded). In another suitable embodiment, the first bipolar plate 12, the second bipolar plate 14, and insert member 16 can be held in assembly by subjecting the bipolar plate assembly 10 to a suitable compression force. For example, the bipolar plate assembly can be subjected to a compression force of 100 psi or greater. In still other suitable embodiments, the first and/or second bipolar plates 12, 14 can be molded (e.g., overmolding, compression molding) to the insert member 16.

During use, the channels 36 are designed to distribute reactant evenly across the fuel cell's membrane electrode assembly (MEA). Accordingly, the area of the primary faces 18, 20 of the bipolar plate assembly comprising the channels 36 roughly defines the fuel cell's “active-area”. The active-area is the region where chemical reactions take place during operation of the fuel cell. As a result, the active area is the region of the fuel cell where heat from the reaction originates. The geometry of the active-area (e.g., generally rectangular in the illustrated embodiment) is designed so that the fuel cell will produce the desired rated power.

As explained in more detail below, the illustrated bipolar plate assembly 10 has an in-plane thermal conductivity sufficient to conduct the heat from the active area to at least one of the longitudinal side faces 22, 24 and the lateral side faces 26, 28. In one suitable embodiment, the bipolar plate assembly 10 has an in-plane thermal conductivity sufficient to conduct the heat from the active area to both of the longitudinal side faces 22, 24 of the bipolar plate assembly 10. As a result, a fuel cell stack comprising a plurality of the illustrated bipolar plate assemblies 10 can be cooled by mating a heat exchanger to the longitudinal side faces 22, 24 of each of the bipolar plate assemblies defining the stack. In one suitable embodiment, the heat exchanger is a cold plate. Suitable heat exchangers are described in U.S. patent Ser. No. 13/566,347 filed Aug. 3, 2012 and entitled FUEL CELL STACK HAVING A STRUCTURAL HEAT EXCHANGER, which is hereby incorporated by reference in its entirety.

Moreover, the in-plane thermal conductivity of each of the bipolar plate assemblies 10 is sufficiently high such that the temperature difference between any two points on the MEA is minimal. A relatively uniform temperature distribution across the MEA within a desired temperature range enhances both performance and durability of the fuel cell. For some high temperature fuel cells, for example, the desired operation temperature is in a range between 160° C. and 170° C. Other suitable operating temperature ranges of MEAs include temperatures between 150° C. and 180° C. If the MEAs are operated substantially lower than this operating temperature range, the fuel cell stack performance is reduced. Alternatively, if the MEAs are operated substantially higher than this operating temperature range, the fuel cells may become damaged by the excessive heat.

As seen in FIGS. 1-3, both of the first and second bipolar plates 12, 14 of the illustrated bipolar plate assembly 10 include a non-adhesive coating 31 comprising a polymer or an elastomer, i.e. FKM (VITON available from E.I du Pont de Numours and Company of Wilmington, Del., U.S.A.) for achieving a seal between the first and second bipolar plates 12, 14 and the respective MEA (not shown). It is understood, however, that adhesives and/or other suitable bonded/sealing materials can be used between the first and second bipolar plates 12, 14 and MEAs. Suitably, the thickness of the coating 31 is minimized. For example, suitable coating thicknesses include thicknesses that are less than 0.003 inches, less than 0.002 inches, less than 0.001 inches, and less than 0.0005 inches. Other suitable coating materials include silicone, fluorosilicone (FVS), ethylene propylene diene monomer (EPDM), tetrafluoroethylene/propylene (i.e. AFLAS available from Asahi Glass Company of Tokyo, Japan), chlorinated polyethylene, chloro-sulfonated polyethylene (i.e. HYPALON available from E.I du Pont de Numours and Company of Wilmington, Del., U.S.A.), polysulfide rubber (PTR), polysulfone (PSU), polyphenylene sulfide (PPS), poly ether sulfone (PES), poly ethylene terephalate (PET), poly butylene terephalate (PBT), poly ethylene naphalate (PEN), phenoxy resins, novolac and resol phenolic resins, epoxy vinyl ester resins, epoxy novolac resins, poly tetra fluoro ethylene (PTFE), fluoro ethylene hexa propylene (FEP), per fluoro alkoxy (PFA), ethylene chloro trifluoro ethylene copolymer (ECTFE), poly chloro trifluoro ethylene (PCTFE), poly vinylidene fluoride (PVDF), poly ether imide (PEI), poly ether ether ketone (PEEK), poly ether ketone (PEK), polyimide imide (PAI), polyimide, and poly benz imidazole (PBI).

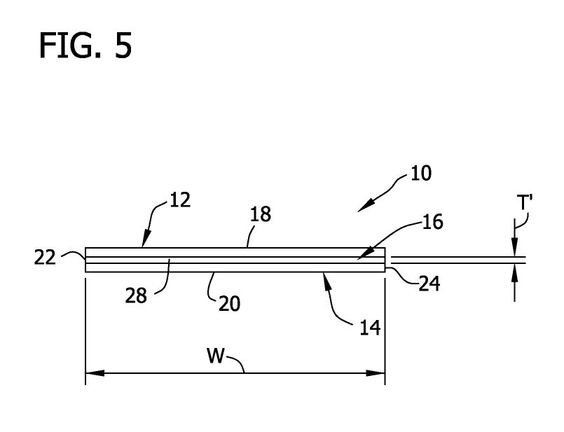

As seen in FIG. 5, the insert member 16 has a width W and a thickness T′. In the illustrated embodiment, for example, the width W of the insert member is 3.8 inches and the thickness is 0.030 inches. Thus, a ratio of the width W of the illustrated insert layer 16 to its thickness T′ is approximately 127. It is contemplated that the ratio of the width W to the thickness T′ of the insert layer 16 can be other than that illustrated in FIG. 5. For example, a range of suitable ratios are from 50 to 400 and more specifically from 190 to 380. Other suitable ratios include ratios less than 400, less than 300, less than 200, less than 150, less than 100, and less than 50.

In the illustrated embodiment, the first and second bipolar plates 12, 14 are made from the same material. However, the insert member 16 is made from a material that is different than the first and second bipolar plates 12, 14. In one suitable embodiment, the first and second bipolar plates 12, 14 are made from a material that is resistant to the fuel cell environment (e.g., temperature, electro-chemistry, reactants, acids), electrically conductive, gas impermeable (e.g., hydrogen impermeable) and has a relative low in-plane thermal conductivity (˜40 W/mK).

For example, the first and second bipolar plates 12, 14 can be a relatively inexpensive, moldable composite comprising graphite filler in a polymer resin. Examples include moldable graphite/thermoset phenolic composites such as BMC 955 available from Bulk Molding Compounds, Inc. of West Chicago, Ill., U.S.A. and BBP4 available from SGL Carbon GmbH of Wiesbaden, Germany. Other suitable materials include, for example, moldable graphite/thermoplastic composites, such as BMA5 and PPG86 also available from SGL Carbon GmbH of Wiesbaden, Germany.

In one suitable embodiment, the material of the first and second bipolar plates 12, 14 has the tensile strength greater than 30 MPa, more suitably greater than 35 MPa, even more suitably greater than 40 MPa, and most suitably greater than 45 MPa. The flexural strength of the suitable material for the first and second bipolar plates 12, 14 would be greater than 30 MPa, more suitably greater than 35 MPa, even more suitably greater than 40 MPa, greater than 45 MPa, and most suitably greater than 50 MPa. The suitable material for the first and second bipolar plates 12, 14 would also have both a flexural modulus and a tensile modulus greater than 10 GPa, more suitably greater than 15 GPa, and even more suitably greater than 20 GPa.

Suitably, the in-plane electrical conductivity of the material would be less than 300 S/cm, more suitably less than 200 S/cm, even more suitably less than 100 S/cm, less than 80 S/cm, and most suitably less than 60 S/cm while the through-plane electrical conductivity of the material would suitably be greater than 5 S/cm, more suitably greater than 10 S/cm, even more suitably greater than 20 S/cm, greater than 30 S/cm, greater than 40 S/cm, and most suitably greater than 50 S/cm. Suitably the in-plane thermal conductivity of the material would be less than 60 W/mK, more suitably less than 50 W/mK, even more suitably less than 40 W/mK, less than 30 W/mK, less than 20 W/mK, and most suitably less than 10 W/mK while the through-plane thermal conductivity of the material would suitably be greater than 5 W/mK, more suitably greater than 10 W/mK, even more suitably greater than 15 W/mK, greater than 20 W/mK, and most suitably greater than 25 W/mK.

Suitably the through-plane thermal expansion of the material would be less than 90 ppm/° C., more suitably less than 60 ppm/° C., even more suitably less than 30 ppm/° C., and most suitably less than 25 ppm/° C. while the in-plane thermal expansion of the material would suitably be greater than 0 ppm/° C., more suitably greater than 1 ppm/° C., even more suitably greater than 5 ppm/° C., greater than 10 ppm/° C., greater than 15 ppm/° C., greater than 20 ppm/° C., and most suitably greater than 25 ppm/° C. The density of the material of the first and second bipolar plates 12, 14 would suitably be greater than 1.5 g/cc, greater than 1.6 g/cc, greater than 1.7 g/cc, greater than 1.8 g/cc, greater than 1.9 g/cc, and more suitably greater than 2.0 g/cc.

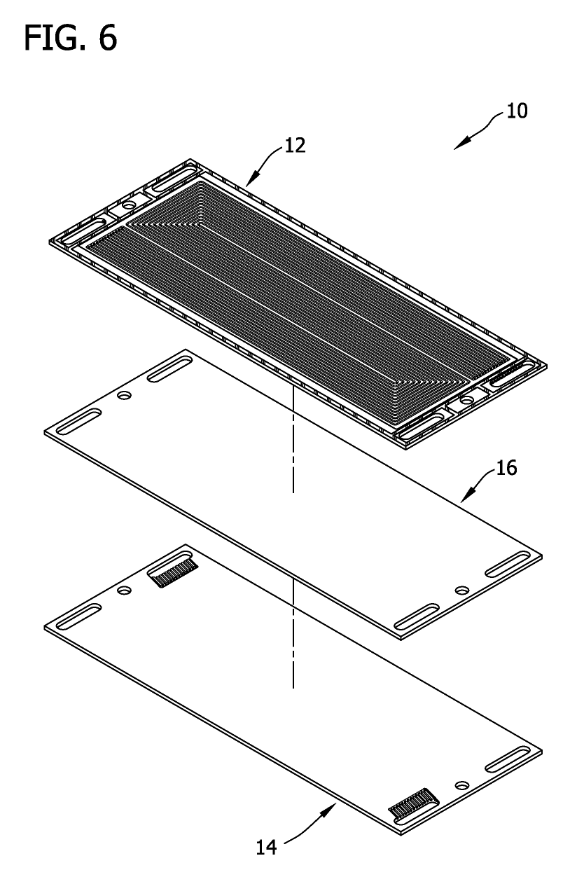

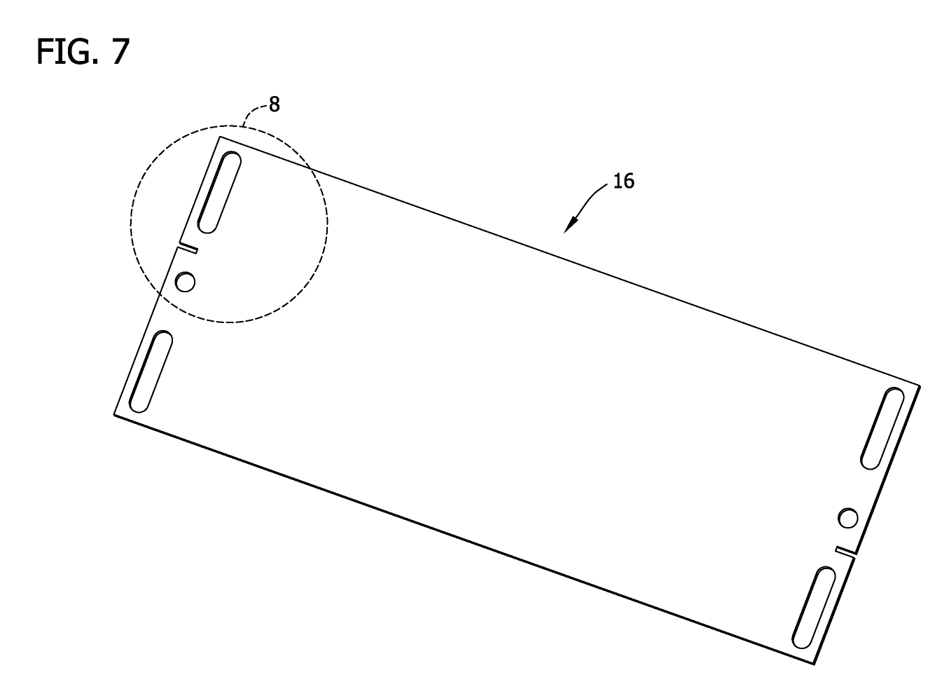

The insert member 16, which is illustrated in FIGS. 6 and 7, has a relatively high thermal conductivity to facilitate heat removal from the fuel cell. In one suitable embodiment, the insert member 16 is made from a material that is resistant to the fuel cell environment (e.g., temperature, electro-chemistry, reactants, acids), electrically conductive, gas impermeable (e.g., hydrogen impermeable) and has a relatively high in-plane thermal conductivity (500 W/mK). However, the material of the insert member 16 can be less resistant to acid, products and reactants and have an increased permeability to hydrogen as compared to the material of the bipolar plates 12, 14. Since the material of the insert member 16 is more costly compared to the material of the bipolar plates, it is desirable to minimize the amount of insert member material used in the bipolar plate assembly 10.

Materials suitable for use as the insert member 16 include, but are not limited to, a graphite foil comprising expanded natural or synthetic graphite that has been expanded or exfoliated and then recompressed. Examples include SPREADERSHIELD and GRAFOIL available from Graftech International Holdings of Parma, Ohio, U.S.A. and SIGRAFLEX available from SGL Carbon GmbH, of Wiesbaden, Germany. Other suitable materials include, for example, metal clad graphite foils, polymer impregnated graphite foils, other forms of carbon, including CVD carbon and carbon-carbon composites, silicon carbide, and high thermal conductivity metals or alloys containing aluminum, beryllium, copper, gold, magnesium, silver and tungsten.

In one suitable embodiment, the material used for the insert member 16 has both a flexural strength and a tensile strength less than 50 MPa, more suitably less than 40 MPa, even more suitably less than 30 MPa, less than 20 MPa, and most suitably less than 10 MPa. The material suitable for the insert member 16 would also have both a flexural modulus and a tensile modulus less than 20 GPa, more suitably less than 15 GPa, even more suitably less than 10 GPa, and most suitably less than 5 GPa.

Suitably, the in-plane electrical conductivity of the material would be greater than 100 S/cm, more suitably greater than 500 S/cm, even more suitably greater than 1,000 S/cm, and most suitably greater than 2,000 S/cm while the through-plane electrical conductivity of the material would suitably be less than 50 S/cm, more suitably less than 40 S/cm, even more suitably less than 30 S/cm, less than 20 S/cm, less than 15 S/cm, and most suitably less than 10 S/cm. Suitably, the through-plane thermal conductivity of the material would be less than 20 W/mK, more suitably less than 15 W/mK, even more suitably less than 10 W/mK, less than 5 W/mK, and most suitably less than 3 W/mK while the in-plane thermal conductivity of the material would suitably be greater than 100 W/mK, more suitably greater than 200 W/mK, even more suitably greater than 300 W/mK, greater than 400 W/mK, and most suitably greater than 500 W/mK.

Suitably the through-plane thermal expansion of the material would be less than 90 ppm/° C., more suitably less than 60 ppm/° C., even more suitably less than 30 ppm/° C., and most suitably less than 25 ppm/° C. and the in-plane thermal expansion of the material would suitably be less than 5 ppm/° C., more suitably less than 3 ppm/° C., even more suitably less than 1 ppm/° C., less than 0 ppm/° C., and most suitably less than −0.3 ppm/° C. The density of the material of the insert member 16 would suitably be less than 1.9 g/cc, less than 1.8 g/cc, less than 1.7 g/cc, less than 1.6 g/cc, less than 1.5 g/cc, and more suitably less than 1.4 g/cc.

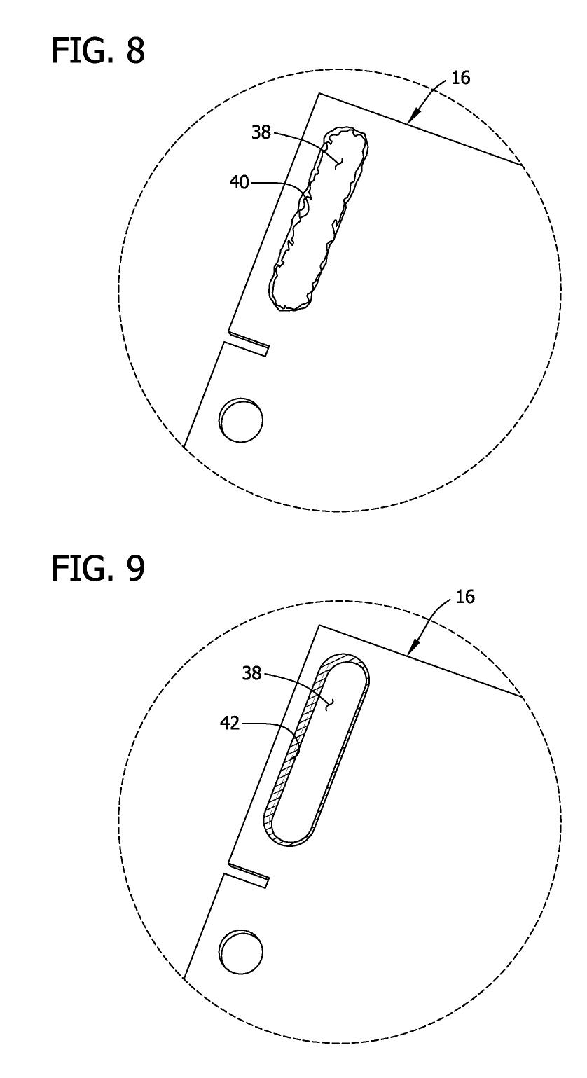

In one suitable embodiment, the insert member 16 can be formed by die cutting. It has been found, however, that die cutting some of the materials suitable for use as the insert member 16 may result in the periphery edges of the insert member having loose particles. As seen in FIG. 8, for example, a generally racetrack shaped aperture 38 in the insert member 16 formed by die cutting has a plurality of loose particles 40 adjacent to and/or extending into the aperture. These loose particles 40 have the potential of becoming entrained in any fluid being driven through one of the apertures 30 in the bipolar plate assembly 10 and into the channels 36 or more broadly, into the fluid stream. As a result, the particles 40 can be carried to various locations within the fuel cell where they may block passages, prevent valves from fully closing, etc. Also, the particles 40 of insert member material are electrically conductive and therefore could potentially result in unwanted conductive bridges forming within the fuel cell. In other words, any loose particles 40 resulting from the die cutting process that break free and enter the fluid stream can potentially adversely effect the operation of the fuel cell.

To inhibit any potentially loose particles 40 along the periphery edges of the insert member 16 from breaking free and mixing with the fluid, the periphery edges of the insert member can be encapsulated. FIG. 9, for example, illustrates the racetrack shaped aperture 38 of the insert member 16 being encapsulated by a suitable encapsulant 42. In one suitable embodiment, the encapsulant 42 is a potting material. In one embodiment, the potting material can be soft upon curing and, in another embodiment, the potting material can be hard upon curing. In one suitable example, the encapsulant 42 can be a fluoroelastomer (e.g. VITON available from E.I du Pont de Numours and Company of Wilmington, Del., U.S.A.). Other suitable encapsulants include, for example, silicone, fluorosilicone (FVS), ethylene propylene diene monomer (EPDM), tetrafluoroethylene/propylene (e.g., AFLAS available from Asahi Glass Company of Tokyo, Japan), chlorinated polyethylene, chloro-sulfonated polyethylene (e.g., HYPALON available from E.I du Pont de Numours and Company of Wilmington, Del., U.S.A.), polysulfide rubber (PTR), polysulfone (PSU), polyphenylene sulfide (PPS), poly ether sulfone (PES), poly ethylene terephalate (PET), poly butylene terephalate (PBT), poly ethylene naphalate (PEN), phenoxy resins, novolac and resol phenolic resins, epoxy vinyl ester resins, epoxy novolac resins, poly tetra fluoro ethylene (PTFE), fluoro ethylene hexa propylene (FEP), per fluoro alkoxy (PFA), ethylene chloro trifluoro ethylene copolymer (ECTFE), poly chloro trifluoro ethylene (PCTFE), poly vinylidene fluoride (PVDF), poly ether imide (PEI), poly ether ether ketone (PEEK), poly ether ketone (PEK), polyimide imide (PAI), polyimide, poly benz imidazole (PBI), and combinations thereof. The encapsulant 42 may also be in the form a material crimped around the edge. The encapsulated edge may be slightly raised relative to the other portions of the insert member. In such an embodiment, a relief (e.g., recess, cutout (not shown)) may be formed in one or both of the first and second bipolar plates 12, 14 to accommodate the thickness of the encapsultant 42.

As mentioned above, adhesive can be used to bond the first and second bipolar plates 12, 14 to the insert member 16. It is understood that the insert member 16 can be bonded to one or both of the first and second bipolar plates 12, 14 or that the insert member can be free from bonding. In an embodiment wherein the insert member 16 is free of bonding, the first bipolar plate 12, the second bipolar plate 14, and insert member can be held in assembly by capturing the insert member between the first and second bipolar plates and/or subjecting the bipolar plate assembly 10 to a compression force. For example, the illustrated bipolar plate assembly 10 can be held together without adhesive by subjecting the assembly to a compression force of 100 psi or greater. In another suitable embodiment, the illustrated bipolar plate assembly 10 can be held in assembly by adhesively bonding the first and second bipolar plates 12, 14 together and capturing the insert member 16 between the first and second bipolar plates. In one such embodiment, the insert member 16 is not capable of being adhesively bonded or sufficiently adhesively bonded to other insert members or to the first and second bipolar plates 12, 14. In such an embodiment, however, the first and second bipolar plates 12, 14 can be sufficiently adhesively bonded together to hold the first bipolar plate, the second bipolar plate, and the insert member 16 in assembly.

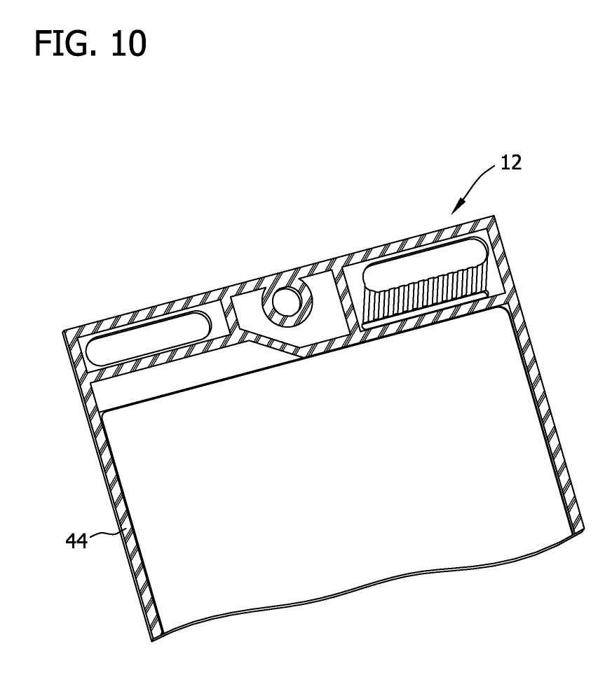

In one suitable embodiment, an adhesive 44, which can be either electrically conductive or non-conductive, can be applied to one of or both of the first and second bipolar plates 12, 14. In the embodiment illustrated in FIG. 10, for example, adhesive 44 is applied to the inner surface of the first bipolar plate 12 along a line generally adjacent its periphery and around openings formed therein. It is contemplated, however, that adhesive 44 can be applied to the first and/or second bipolar plate 12, 14 or the insert member 16 in different patterns and in different amounts than those illustrated in FIG. 10. Suitably, the adhesive 44 is applied in such a manner that the thickness of the adhesive is minimized so that sufficient contact between the insert member 16 and the first and second bipolar plates 12, 14 can be maintained. For example, suitable adhesive thicknesses include thicknesses that are less than 0.003 inches, less than 0.002 inches, less than 0.001 inches, and less than 0.0005 inches. It is also contemplated that the adhesively bonded bipolar plate assembly 10 can be subjected to a suitable compression force. The compression force in this embodiment can between 10 psi and 500 psi. In one suitable embodiment, for example, the compression force is 100 psi.

Suitable adhesives are well known to those skilled in the art. In one embodiment the adhesive 44 is a thermally activated adhesive. Thermally activated adhesives can be any adhesive that meet fuel cell requirements (e.g., operating temperatures between 120° C. and 200° C., pressures up to 300 kPa, compatible with an acidic membrane, hydrogen, air, and water, and being an electrical insulator). Suitable thermally activated adhesives include, but are not limited to, ethylene vinyl acetate (EVA), ethylene acrylic acid (EAA), polyamide, polyesters, polyolefins, polyurethanes, and combinations thereof.

In another embodiment, a non-adhesive coating comprising a polymer or an elastomer, i.e. FKM (VITON available from E.I du Pont de Numours and Company of Wilmington, Del., U.S.A.) can be used instead of, or in addition to, the adhesive 44 in order to achieve an adequate seal at lower compression force (i.e., less than 100 psi). Suitably, the thickness of the coating is minimized. For example, suitable coating thicknesses include thicknesses that are less than 0.003 inches, less than 0.002 inches, less than 0.001 inches, and less than 0.0005 inches. Other suitable coating materials include silicone, fluorosilicone (FVS), ethylene propylene diene monomer (EPDM), tetrafluoroethylene/propylene (i.e. AFLAS available from Asahi Glass Company of Tokyo, Japan), chlorinated polyethylene, chloro-sulfonated polyethylene (i.e. HYPALON available from E.I du Pont de Numours and Company of Wilmington, Del., U.S.A.), polysulfide rubber (PTR), polysulfone (PSU), polyphenylene sulfide (PPS), poly ether sulfone (PES), poly ethylene terephalate (PET), poly butylene terephalate (PBT), poly ethylene naphalate (PEN), phenoxy resins, novolac and resol phenolic resins, epoxy vinyl ester resins, epoxy novolac resins, poly tetra fluoro ethylene (PTFE), fluoro ethylene hexa propylene (FEP), per fluoro alkoxy (PFA), ethylene chloro trifluoro ethylene copolymer (ECTFE), poly chloro trifluoro ethylene (PCTFE), poly vinylidene fluoride (PVDF), poly ether imide (PEI), poly ether ether ketone (PEEK), poly ether ketone (PEK), polyamide imide (PAI), polyimide, and poly benz imidazole (PBI).

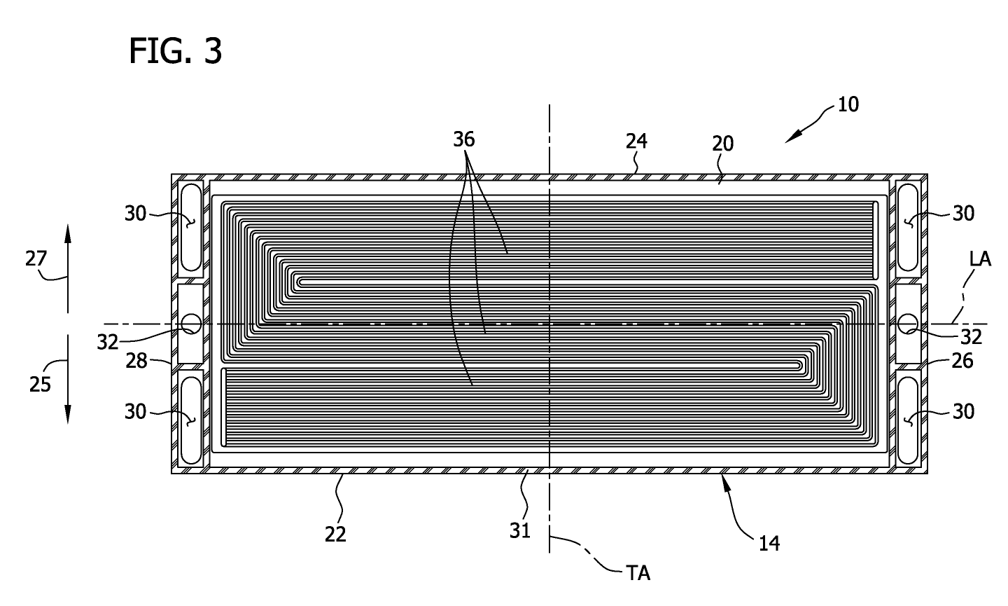

As mentioned above, the illustrated bipolar plate assembly 10 has an in-plane thermal conductivity sufficient to conduct heat from the active area to both of the longitudinal side faces 22, 24 of the bipolar plate assembly 10 where it can be transferred to a suitable heat exchanger. More specifically, as seen in FIG. 6, the insert member 16 is configured so it at least corresponds to the active areas of the bipolar plate assembly 10 (i.e., the areas of the primary faces 18, 20 comprising the channels 36). As a result, heat created at the active areas during operation of the fuel cell is transferred to the insert member 16. Because of the relatively high in-plane thermal conductively of the insert member material, heat is transferred relatively quickly and uniformly throughout the insert member 16. In this embodiment, heat is conducted out both the longitudinal side faces 22, 24 of the bipolar plate assembly 10, which are defined in part by the insert member 16. Suitably, the longitudinal side faces 22, 24 of the bipolar plate assembly 10 provide the shortest distance for heat to be conducted from the bipolar plate assembly 10. More specifically and as illustrated in FIG. 3, the bipolar plate assembly 10 has a longitudinal axis LA and traverse axis TA. Heat generated to the right of the longitudinal axis LA as viewed in FIG. 3 will move generally parallel to the transverse axis TA in the direction of arrow 25 to one of the longitudinal side face 22, and heat generated to the left of the longitudinal axis LA as viewed in FIG. 3 will move generally parallel to the transverse axis TA in the direction of arrow 27 to the other one of the longitudinal side face 24. It is understood that one or both of the longitudinal side faces 22, 24 of the bipolar plate assembly 10 can be operatively connected to the heat exchanger to remove and/or regulate the heat within the fuel cell stack.

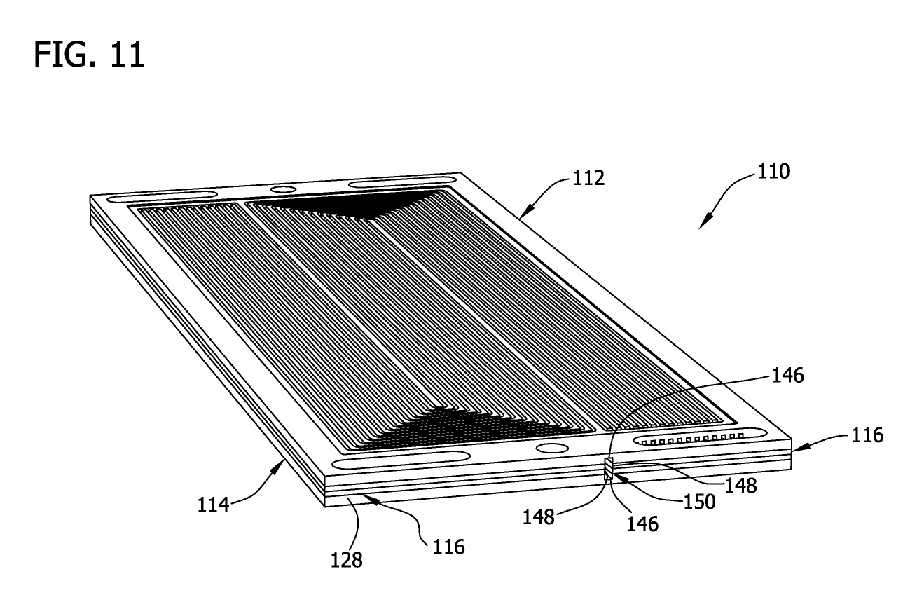

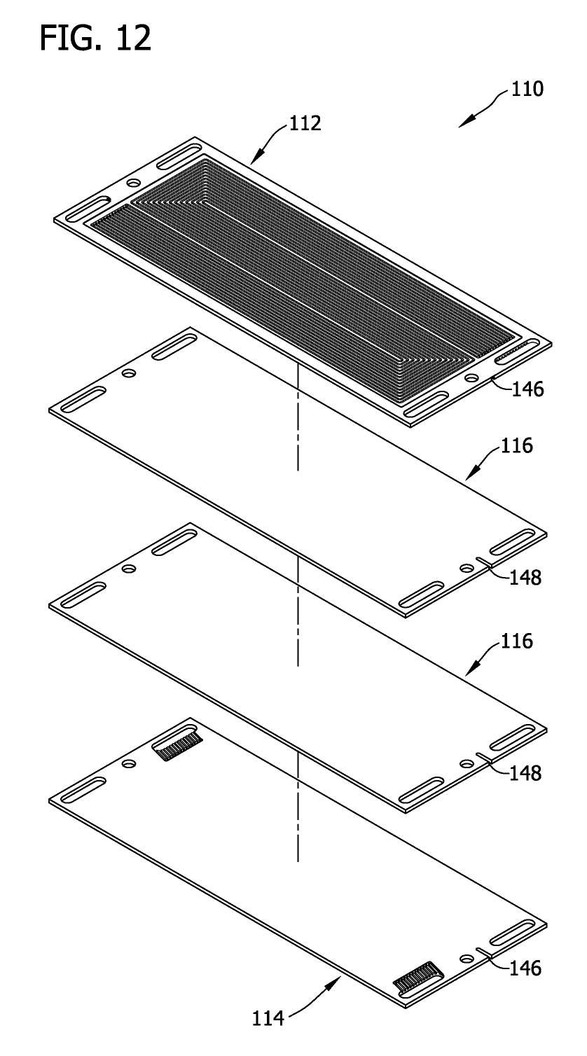

With reference now to FIGS. 11-13, another embodiment of a bipolar plate assembly for use in a fuel cell is generally indicated at 110. As illustrated, the bipolar plate assembly 110 comprises a first bipolar plate 112, a second bipolar plate 114, and two insert members 116 disposed between the first and second bipolar plates. The first and second bipolar plates 112, 114 and the insert member 116 are indicated generally by their respective reference numbers in the accompany drawings. The first and second bipolar plates 112, 114 of this embodiment are similar to the first and second bipolar plates 12, 14 of FIGS. 1-10 and, as a result, will not be described in detail. However, in this embodiment, the first and second bipolar plates 112, 114 include a preformed groove 146.

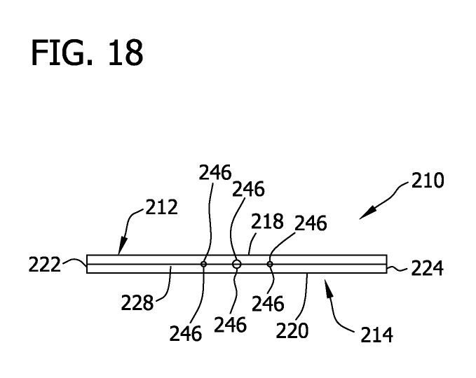

In the illustrated embodiment, each of the grooves 146 has a generally U-shaped cross-section. It is understood, however, that the grooves 146 can have any suitable size and shape. It is also understood the first and second bipolar plates 112, 114 can have more than one groove and that the grooves can have different sizes and shapes. For example, FIG. 18 illustrates a bipolar plate assembly 210 having first and second bipolar plates 212, 214 with three generally circular preformed grooves 246. It is further understood that in some embodiments the grooves 146 in one or both of the first and second bipolar plates 112, 114 can be omitted. It is contemplates that the grooves 146 can be formed in any suitable manner. For example, the grooves 146 can be formed by molding or by machining. In this embodiment, the bipolar plate assembly 110 is assembled after the grooves 146 are formed in the first and second bipolar plates 112, 114. It is contemplated, however, that the grooves 146 can be formed after the bipolar plate assembly 110 is assembled.

Each of the two insert members 116 illustrated in FIGS. 11-13 are similar to the insert member 16 seen in FIG. 1-10. However, each insert member 116 of this embodiment includes preformed cutouts 148 at each of its lateral edges. In the illustrated embodiment, for example, the preformed cutouts 148 can be formed by a die cutting process. It is also contemplated, however, that the cutouts 148 can be formed in the insert members 116 using other suitable techniques (e.g., machining). In this embodiment, the bipolar plate assembly 110 is assembled after the cutouts 148 are formed in the inert members 116. It is contemplated, however, that the cutouts 148 can be formed after the bipolar plate assembly 110 is assembled.

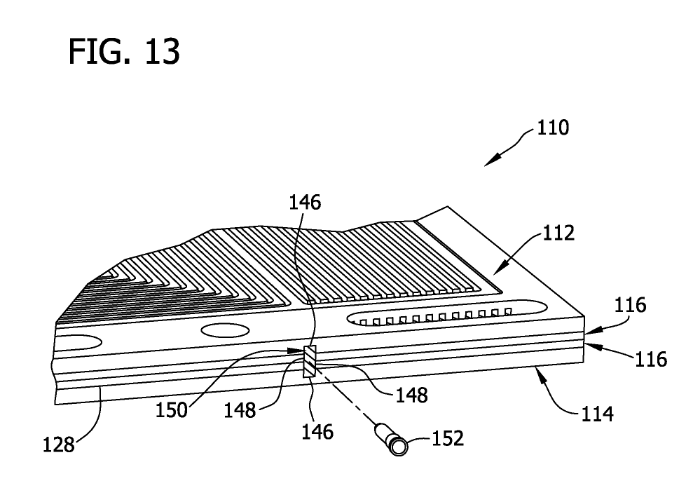

As illustrated in FIGS. 11 and 13, the grooves 146 in the first and second bipolar plates 112, 114 and the cutouts 148 in the insert members 116 are aligned and thereby cooperatively define a pocket, indicated generally at 150, formed in at least of the lateral edges (only one of the lateral edges 128 being illustrated in FIGS. 11 and 13) of the bipolar plate assembly 110. In one suitable embodiment, the pocket 150 can be sized and shaped for receiving a voltage receptacle 152 (broadly, “an insert device”). It is contemplated, however, that the bipolar plate assembly 110 can have more or fewer pockets 150 and that the pockets can be disposed at any suitable location on the bipolar plate assembly. It is also contemplated that the pocket 150 can have any suitable size or shape and can be used to receive different types of receptacles, sockets or probes (e.g., suitable electrical and/or temperature sensors). In one suitable embodiment, for example, the pockets 150 can be used to receive thermocouples.

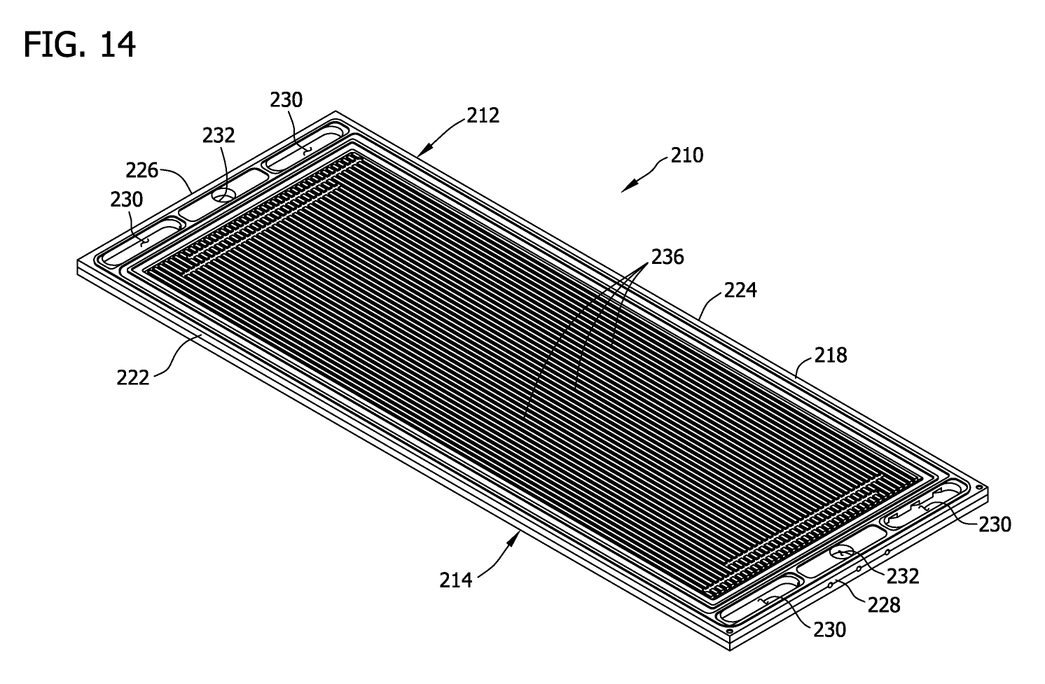

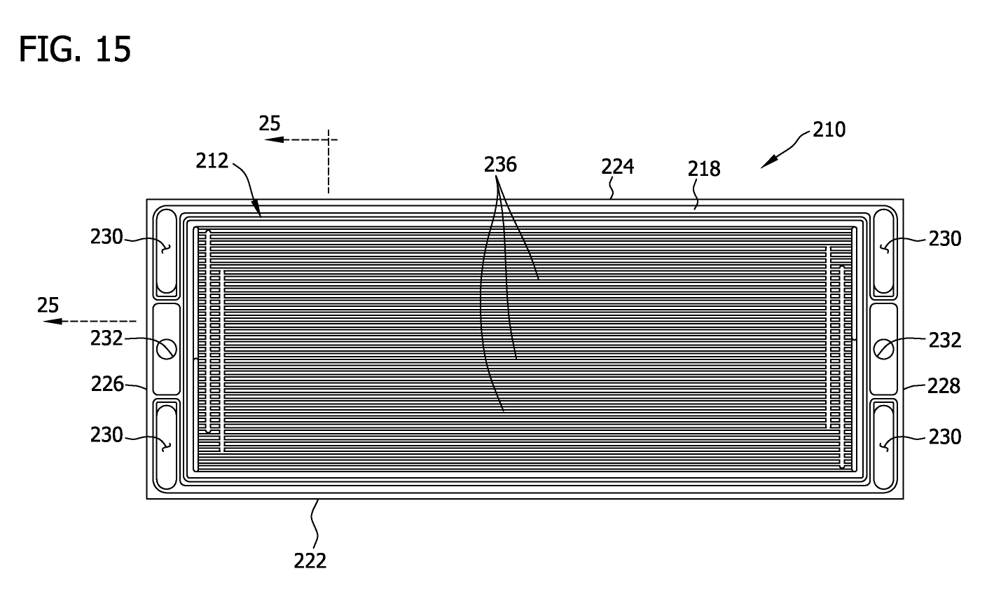

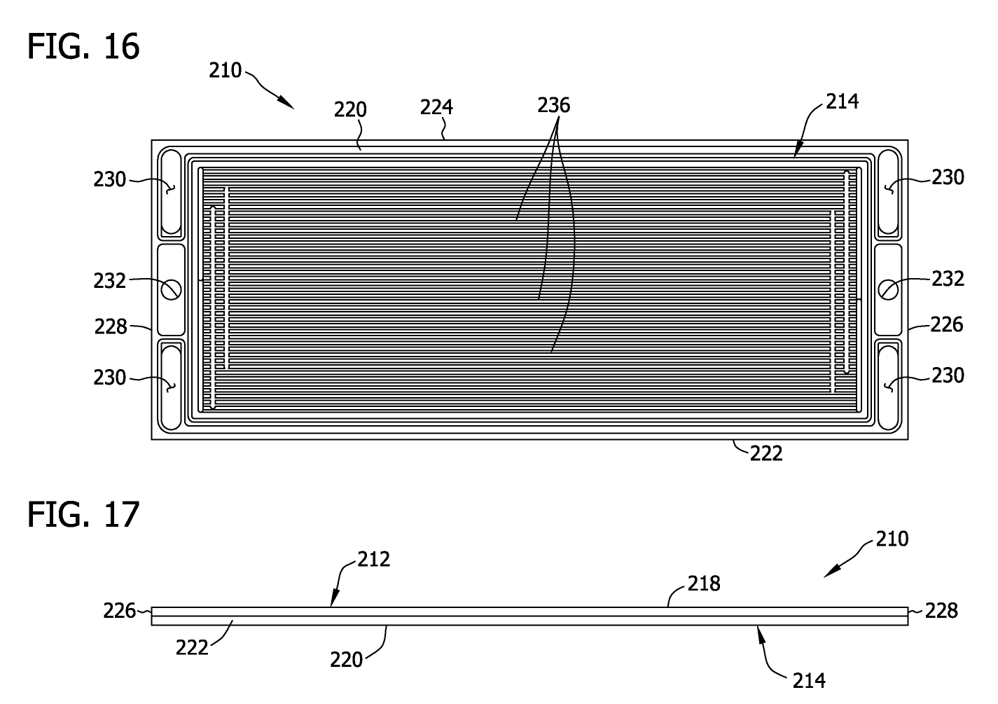

FIGS. 14-19 illustrate yet another embodiment of a bipolar plate assembly for use in a fuel cell, which is generally indicated at 210. As illustrated, the bipolar plate assembly 210 comprises a first bipolar plate 212, a second bipolar plate 214, and at least one insert member 216 disposed between the first and second bipolar plates. The first and second bipolar plates 212, 214 and the insert member 216 are indicated generally by their respective reference numbers in the accompany drawings. In the illustrated embodiment, the bipolar plate assembly 210 has a generally rectangular box shape (i.e., a right cuboid). Accordingly, the illustrated bipolar plate assembly 210 has six generally rectangular faces. More specifically, the bipolar plate assembly 210 has a pair of opposed primary faces (i.e., a front face 218 and a back face 220), a pair of longitudinal side faces 222, 224, and a pair of lateral side faces 226, 228. It is understood, however, that the bipolar plate assembly 210 can have any suitable shape.

The bipolar plate assembly 210 includes four apertures 230 for allowing fluid (gas and/or liquid) to pass through the bipolar plate assembly. As seen in FIGS. 14-16, each of the apertures 230 extends through the primary faces 218, 220 adjacent respective corners of the bipolar plate assembly 210. It is understood that the bipolar plate assembly 210 can have more or fewer apertures 230 and that the apertures can be disposed at locations different than those illustrated in FIGS. 14-16. In the illustrated embodiment, each of the apertures 230 has a generally racetrack shape but it is understood that the apertures can have any suitable shape (i.e., circle, rectangular, elliptical). The bipolar plate assembly 210 also includes a pair of generally circular openings 232 for allowing a dowel (or tie rod) to extend through the bipolar plate assembly. While the openings 232 in the illustrated embodiment are generally circular, it is understood that the openings 232 can be any suitable shape (i.e., square, elliptical, triangular). It is also understood that in some embodiments of the bipolar plate assembly 210, the openings 232 can be omitted.

Each of the primary faces 218, 220 of the bipolar plate assembly 210 has a plurality of channels 236 for distributing fluid across the respective primary face. In the illustrated embodiment, the channels 236 on the front primary face 218 are fluidly connected to two of the apertures 230 and the channels 236 on the back primary face 220 are fluidly connected to the other two apertures 230. As a result, one of the apertures 230 acts as an inlet for the channels 236 and the other aperture in fluid communication with the same channel acts as an outlet. The illustrated channels 236 define a generally linear pathway for the fluid as the fluid flows from the aperture 230 defining the inlet to the aperture defining the respective outlet. In the illustrated embodiment, the channels 236 extend longitudinally but it is understood that the channels can extend laterally or diagonally (i.e., at angles relative to the longitudinal and lateral axes of the bipolar plate assembly 210). It is also understood that the primary faces 218, 220 of the bipolar plate assembly 210 can have more or fewer channels than those illustrated in the accompanying drawings. It is further understood that the primary faces 218, 220 can have a different number of channels. That is, for example, the front primary face 218 can have more or fewer channels than the back primary face 220.

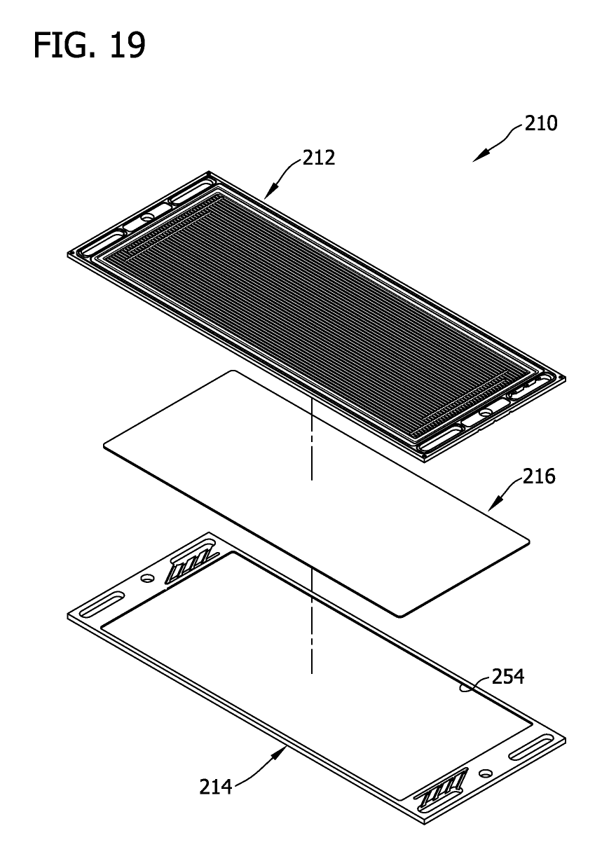

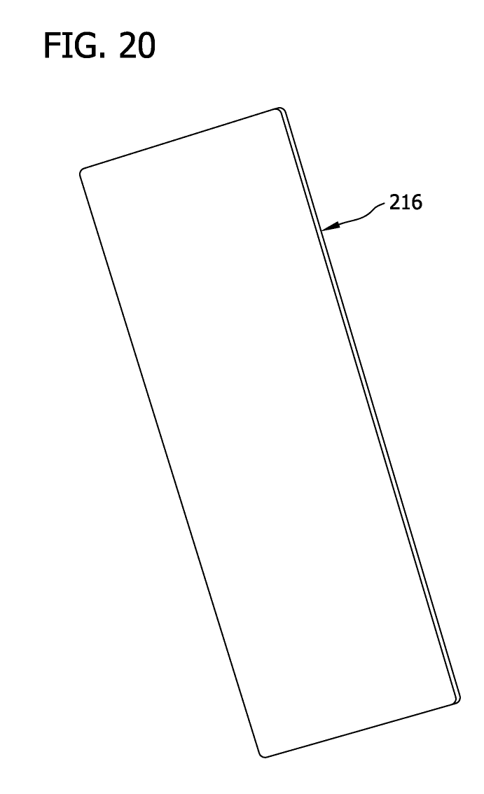

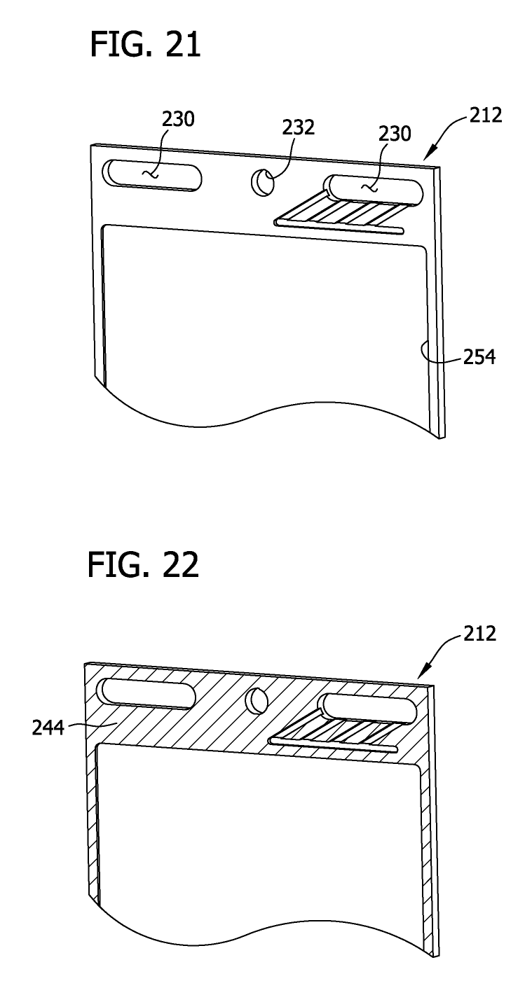

In this embodiment of the bipolar plate assembly 210, the first and second bipolar plates 212, 214 include recesses 254 formed in their inner surfaces. The recess 254 in the second bipolar plate is illustrated in FIG. 19 and part of the recess in the first bipolar plate is illustrated in FIG. 21. In the illustrated embodiment, the recesses 254 in the first and second bipolar plates 212, 214 have substantially the same size and shape and cooperatively define an interior chamber of the bipolar plate assembly 210 that is sized and shaped for receiving the insert member 216. The insert member 216 of this embodiment, which is a generally rectangular uniform plate, is illustrated in FIG. 20. As seen in FIG. 20, this embodiment of the insert member 216 is free of apertures and, as a result, no portion of the insert member 216 defines any part of the fluid apertures 230 in the bipolar plate assembly 210. In fact, the insert member 216 of this embodiment is spaced from the apertures 230 in the bipolar plate assembly 210 thereby inhibiting any fluid flowing through the fuel cell from contacting the insert member.

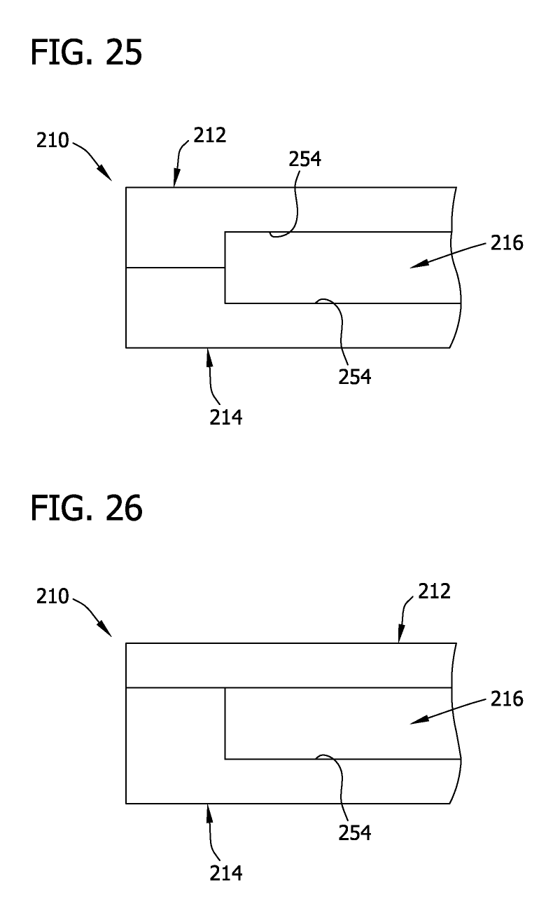

In one suitable embodiment, adhesive can be used to bond the first and second bipolar plates 212, 214 together. It is understood that the insert member 216 can be bonded to one or both of the first and second bipolar plates 212, 214 or that the insert member can be free from bonding. As seen in FIG. 25, the insert member 216 is captured within the interior chamber defined by the recesses 254 in the first and second bipolar plates 212, 214. The adhesive, which can be either electrically conductive or non-conductive, can be applied to one of or both the first and second bipolar plates 212, 214. Suitable adhesives are described herein above and include ethylene vinyl acetate (EVA), ethylene acrylic acid (EAA), polyimide, polyesters, polyolefins, polyurethanes, and combinations thereof.

In the embodiment illustrated in FIG. 22, for example, adhesive 244 is applied to the inner surface of the first bipolar plate 212. As seen in FIG. 22, the entire surface of the first bipolar plate 212 that contacts the second bipolar plate 214 is covered with adhesive 244 to thereby maximize the adhesive bond between the bipolar plates. It is understood that adhesive 244 can be applied to the second bipolar plate 214 in a similar manner or the second bipolar plate can be free from adhesive. It is contemplated, however, that adhesive 244 can be applied to the first and/or second bipolar plate 212, 214 in different patterns and in different amounts than those illustrated in FIG. 22. Suitably, the thickness of the adhesive 244 is minimized. For example, suitable adhesive thicknesses include thicknesses that are less than 0.003 inches, less than 0.002 inches, less than 0.001 inches, and less than 0.0005 inches. It is also contemplated that the adhesively bonded bipolar plate assembly 210 can be subjected to a suitable compression force. The compression force in this embodiment can between 10 psi and 500 psi. In one suitable embodiment, for example, the compression force is 100 psi.

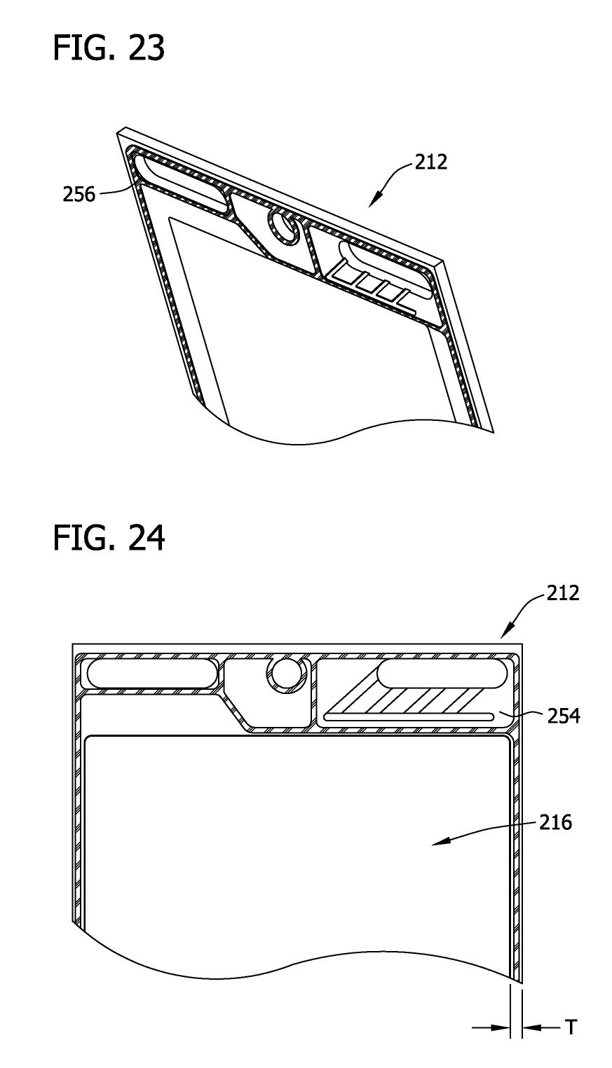

In another embodiment, which is illustrated in FIG. 23, a non-adhesive coating 256 comprising a polymer or an elastomer, i.e. FKM (VITON available from E.I du Pont de Numours and Company of Wilmington, Del., U.S.A.) can be used instead of or in addition to the adhesive 244 in order to achieve an adequate seal at lower compression force (i.e., less than 100 psi). Suitably, the thickness of the coating 256 is minimized. For example, suitable coating thickness include thickness that are less than 0.003 inches, less than 0.002 inches, less than 0.001 inches, and less than 0.0005 inches. Other suitable coating 256 materials include silicone, fluorosilicone (FVS), ethylene propylene diene monomer (EPDM), tetrafluoroethylene/propylene (i.e. AFLAS available from Asahi Glass Company of Tokyo, Japan), chlorinated polyethylene, chloro-sulfonated polyethylene (i.e. HYPALON available from E.I du Pont de Numours and Company of Wilmington, Del., U.S.A.), polysulfide rubber (PTR), polysulfone (PSU), polyphenylene sulfide (PPS), poly ether sulfone (PES), poly ethylene terephalate (PET), poly butylene terephalate (PBT), poly ethylene naphalate (PEN), phenoxy resins, novolac and resol phenolic resins, epoxy vinyl ester resins, epoxy novolac resins, poly tetra fluoro ethylene (PTFE), fluoro ethylene hexa propylene (FEP), per fluoro alkoxy (PFA), ethylene chloro trifluoro ethylene copolymer (ECTFE), poly chloro trifluoro ethylene (PCTFE), poly vinylidene fluoride (PVDF), poly ether imide (PEI), poly ether ether ketone (PEEK), poly ether ketone (PEK), polyimide imide (PAI), polyimide, and poly benz imidazole (PBI).

During use, the channels 236 are designed to distribute reactant evenly across the fuel cell's membrane electrode assembly (MEA). Accordingly, the area of the primary faces 218, 220 of the bipolar plate assembly comprising the channels 236 roughly defines the fuel cell's “active-area”. The active-area is the region where chemical reactions take place during operation of the fuel cell. As a result, the active area is the region of the fuel cell where heat from the reaction originates. The geometry of the active-area (e.g., generally rectangular in the illustrated embodiment) is designed so that the fuel cell will produce the desired rated power.

As explained in more detail below, the illustrated bipolar plate assembly 210 has an in-plane thermal conductivity sufficient to conduct the heat from the active area to at least one of the longitudinal side faces 222, 224 and the lateral side faces 226, 228. In one suitable embodiment, the bipolar plate assembly 210 has an in-plane thermal conductivity sufficient to conduct the heat from the active area to both of the longitudinal side faces 222, 224 of the bipolar plate assembly 210. As a result, a fuel cell stack comprising a plurality of the illustrated bipolar plate assemblies 210 can be cooled by mating a heat exchanger to the longitudinal side faces 222, 224 of each of the bipolar plate assemblies defining the stack. In one suitable embodiment, the heat exchanger is a cold plate. Moreover, the in-plane thermal conductivity of each of the bipolar plate assemblies 210 within the fuel cell is sufficiently high such that the temperature difference between any two points on the MEA is minimal. A relatively uniform temperature distribution across the MEA within a desired temperature range enhances both performance and durability of the fuel cell.

In the illustrated embodiment, the first and second bipolar plates 212, 214 are made from the same material. However, the insert member 216 is made from a material that is different than the first and second bipolar plates 212, 214. In one suitable embodiment, the first and second bipolar plates 212, 214 are made from a material that is resistant to the fuel cell environment (e.g., temperature, electro-chemistry, reactants, acids), electrically conductive, gas impermeable (e.g., hydrogen impermeable) and has a relative low in-plane thermal conductivity (˜40 W/mK).

For example, the first and second bipolar plates 212, 214 can be relatively inexpensive, moldable composite comprising graphite filler in a polymer resin. Examples include moldable graphite/thermoset phenolic composites such as BMC 955 available from Bulk Molding Compounds, Inc. of West Chicago, Ill., U.S.A. and BBP4 available from SGL Carbon GmbH of Wiesbaden, Germany. Other suitable materials include, for example, moldable graphite/thermoplastic composites, such as BMA5 and PPG86 also available from SGL Carbon GmbH of Wiesbaden, Germany.

In one suitable embodiment, the material of the first and second bipolar plates 212, 214 has the tensile strength greater than 30 MPa, more suitably greater than 35 MPa, even more suitably greater than 40 MPa, and most suitably greater than 45 MPa. The flexural strength of the suitable material for the first and second bipolar plates 212, 214 would be greater than 30 MPa, more suitably greater than 35 MPa, even more suitably greater than 40 MPa, greater than 45 MPa, and most suitably greater than 50 MPa. The suitable material for the first and second bipolar plates 212, 214 would also have both a flexural modulus and a tensile modulus greater than 10 GPa, more suitably greater than 15 GPa, and even more suitably greater than 20 GPa.

Suitably, the in-plane electrical conductivity of the material would be less than 300 S/cm, more suitably less than 200 S/cm, even more suitably less than 100 S/cm, less than 80 S/cm, and most suitably less than 60 S/cm while the through-plane electrical conductivity of the material would suitably be greater than 5 S/cm, more suitably greater than 10 S/cm, even more suitably greater than 20 S/cm, greater than 30 S/cm, greater than 40 S/cm, and most suitably greater than 50 S/cm. Suitably the in-plane thermal conductivity of the material would be less than 60 W/mK, more suitably less than 50 W/mK, even more suitably less than 40 W/mK, less than 30 W/mK, less than 20 W/mK, and most suitably less than 10 W/mK while the through-plane thermal conductivity of the material would suitably be greater than 5 W/mK, more suitably greater than 10 W/mK, even more suitably greater than 15 W/mK, greater than 20 W/mK, and most suitably greater than 25 W/mK.

Suitably the through-plane thermal expansion of the material would be less than 90 ppm/° C., more suitably less than 60 ppm/° C., even more suitably less than 30 ppm/° C., and most suitably less than 25 ppm/° C. while the in-plane thermal expansion of the material would suitably be greater than 0 ppm/° C., more suitably greater than 1 ppm/° C., even more suitably greater than 5 ppm/° C., greater than 10 ppm/° C., greater than 15 ppm/° C., greater than 20 ppm/° C., and most suitably greater than 25 ppm/° C. The density of the material of the first and second bipolar plates 212, 214 would suitably be greater than 1.5 g/cc, greater than 1.6 g/cc, greater than 1.7 g/cc, greater than 1.8 g/cc, greater than 1.9 g/cc, and more suitably greater than 2.0 g/cc.

The insert member 216, which is illustrated in FIGS. 19, 20 and 24, has a relatively high thermal conductivity to facilitate heat removal from the fuel cell. In one suitable embodiment, the insert member 216 is made from a material that is resistant to the fuel cell environment (e.g., temperature, electro-chemistry, reactants, acids), electrically conductive, gas impermeable (e.g., hydrogen impermeable) and has a relatively high in-plane thermal conductivity (500 W/mK). However, the material of the insert member 216 can be less resistance to acid, products and reactants and have an increased permeability to hydrogen as compared to the material of the bipolar plates 212, 214. Since the material of the insert member 216 is more costly compared to the material of the bipolar plates, it is desirable to minimize the insert member material used in the bipolar plate assembly 210.

Material suitable for use as the insert member 216 include, but are not limited to, a graphite foil comprising expanded natural or synthetic graphite that has been expanded or exfoliated and then recompressed. Examples include SPREADERSHIELD and GRAFOIL available from Graftech International Holdings of Parma, Ohio, U.S.A. and SIGRAFLEX available from SGL Carbon GmbH, of Wiesbaden, Germany. Other suitable materials include, for example, metal clad graphite foils, polymer impregnated graphite foils, other forms of carbon, including CVD carbon and carbon-carbon composites, silicon carbide, and high thermal conductivity metals or alloys containing aluminum, beryllium, copper, gold, magnesium, silver and tungsten.

In one suitable embodiment, the material used for the insert member 216 has both a flexural strength and a tensile strength less than 50 MPa, more suitably less than 40 MPa, even more suitably less than 30 MPa, less than 20 MPa, and most suitably less than 10 MPa. The material suitable for the insert member 216 would also have both a flexural modulus and a tensile modulus less than 20 GPa, more suitably less than 15 GPa, even more suitably less than 10 GPa, and most suitably less than 5 GPa.

Suitably, the in-plane electrical conductivity of the material would be greater than 100 S/cm, more suitably greater than 500 S/cm, even more suitably greater than 1,000 S/cm, and most suitably greater than 2,000 S/cm while the through-plane electrical conductivity of the material would suitably be less than 50 S/cm, more suitably less than 40 S/cm, even more suitably less than 30 S/cm, less than 20 S/cm, less than 15 S/cm, and most suitably less than 10 S/cm. Suitably the through-plane thermal conductivity of the material would be less than 20 W/mK, more suitably less than 15 W/mK, even more suitably less than 10 W/mK, less than 5 W/mK, and most suitably less than 3 W/mK while the in-plane thermal conductivity of the material would suitably be greater than 100 W/mK, more suitably greater than 200 W/mK, even more suitably greater than 300 W/mK, greater than 400 W/mK, and most suitably greater than 500 W/mK.

Suitably the through-plane thermal expansion of the material would be less than 90 ppm/° C., more suitably less than 60 ppm/° C., even more suitably less than 30 ppm/° C., and most suitably less than 25 ppm/° C. and the in-plane thermal expansion of the material would suitably be less than 5 ppm/° C., more suitably less than 3 ppm/° C., even more suitably less than 1 ppm/° C., less than 0 ppm/° C., and most suitably less than −0.3 ppm/° C. The density of the material of the insert member 16 would suitably be less than 1.9 g/cc, less than 1.8 g/cc, less than 1.7 g/cc, less than 1.6 g/cc, less than 1.5 g/cc, and more suitably less than 1.4 g/cc.

As mentioned above, the illustrated bipolar plate assembly 210 has an in-plane thermal conductivity sufficient to conduct heat from the active area to both of the longitudinal side faces 222, 224 of the bipolar plate assembly 210 where it can be transferred to a suitable heat exchanger. More specifically, as seen in FIG. 24, the insert member 216 is positioned so it generally corresponds to the active areas of the bipolar plate assembly 210 (i.e., the areas of the primary faces 218, 220 comprising the channels 236). As a result, heat created at the active areas during operation of the fuel cell is transferred to the insert member 216. Because of the relatively high in-plane thermal conductively of the insert member material, heat is transferred relatively quickly and uniformly throughout the insert member 216.

In this embodiment, heat is conducted out of the longitudinal side faces 222, 224 of the bipolar plate assembly 210, which are defined by the first and second bipolar plates 212, 214. As a result, heat needs to be transferred from the insert member 216 to the first and second bipolar plates 212, 214 at the longitudinal side faces 222, 224 of the bipolar plate assembly 210. Suitably, the thickness T of the first and second bipolar plates 212, 214 at the longitudinal side faces 222, 224 is minimized so that heat travels only a short distance through the first and second bipolar plates to the heat exchanger (FIG. 24). In one suitable embodiment, the thickness T of the first and second bipolar plates 212, 214 at the longitudinal side faces 222, 224 is between 0.25 inches and 0.5 inches. It is understood, however, that in some embodiments the thickness T of the first and second bipolar plates 212, 214 can be less than 0.25 inches or greater than 0.5 inches.

FIG. 26 is a fragmentary cross-section of another configuration of the bipolar plate assembly 210. In this configuration, the first bipolar plate 212 does not have a recess. That is, the inner surface of the first bipolar plate 212 is generally flat similar to the first bipolar plate 12 illustrated in FIGS. 1-6. The second bipolar plate 214 of this embodiment, however, has a recess 254 that is size and shaped for receiving the insert member 216. As seen in FIG. 26, the first and second bipolar plates 212, 214 define the interior chamber for capturing the insert member 216.

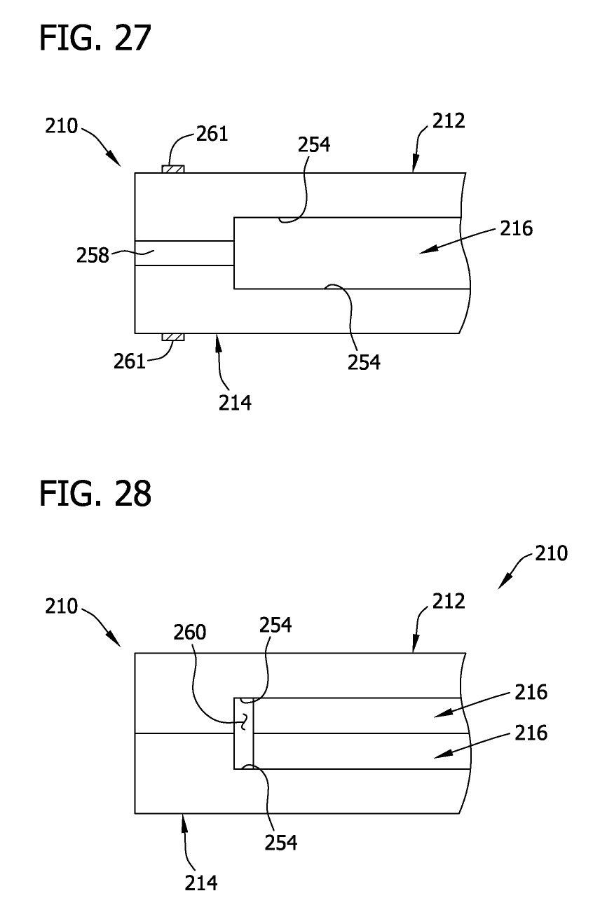

FIG. 27 is a fragmentary cross-section of yet another configuration of the bipolar plate assembly 210. In this configuration, both the first and second bipolar plates 212, 214 have recesses 254. However, the recesses 254 are not deep enough (i.e., too shallow) to define an interior chamber suitable for receiving the insert member 216. As a result, a shim 258 (broadly, “a first adjustment member”) can be added to increase the capacity of the interior chamber. Suitably, the thickness of the shim 258 is less than 0.005 inches, less than 0.004 inches, less than 0.003 inches, less than 0.002 inches, less than 0.001 inches, and less than 0.0005 inches. The shim 258 can be made from any suitable material including, but not limited to, metal foil, metal screen, expanded metal, plated or deposited metal layer, corrugated metal foil, tangled metal foil metal gauze, or the like. Suitable metals include stainless steel, titanium, copper, aluminum, beryllium, gold, silver, magnesium, nickel, cobalt, iron, tungsten and alloys containing the same.

In one suitable use, the shim 258 illustrated in FIG. 27 can be used to compensate for manufacturing tolerances in the first and second bipolar plates 212, 214 and/or the insert member 216. In one suitable embodiment, the face-to-face engagement between the first and second bipolar plates 212, 214 and the insert member 216 is maximized to facilitate thermal and electrical conductance between the first and second bipolar plates and the insert member. Accordingly, the manufacturing tolerances in the first and second bipolar plates 212, 214 and/or the insert member 216 can result in decreased engagement between the first and second bipolar plates 212, 214 and the insert member 216. The shim of FIG. 27 can be used as necessary to compensate for these tolerances and increase the engagement between the first and second bipolar plates 212, 214 and the insert member 216.

FIG. 28 illustrates a configuration of the bipolar plate assembly 210 having two insert members 216. In this configuration, a peripheral gap 260 is provided between outer edges of the insert members 216 and inner edges of the first and second bipolar plates 212, 214. The peripheral gap 260 is provided to accommodate for some manufacturing tolerances (e.g., the width and length of the insert members 216). The bipolar plate assembly 210 illustrated in FIG. 28 also includes a seal 261 disposed adjacent the periphery of the outer surface of the first and second bipolar plates 212, 214. During use of the bipolar plate assembly 210 in a fuel cell stack, the seal 261 is configured to direct compressive forces exerted on the bipolar plate assembly directly between the first and second bipolar plates 212, 214 and away from the insert members 216.

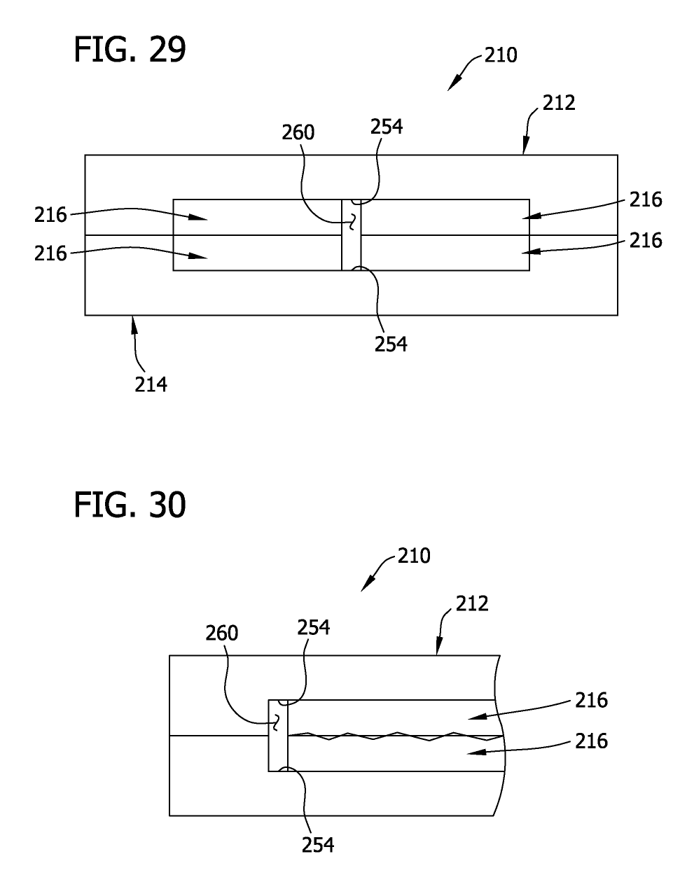

FIG. 29 illustrates another configuration of the bipolar plate assembly 210 having a gap 260 for accommodating some manufacturing tolerances of the first and second bipolar plates 212, 214 and any one of four insert members 216. As seen in FIG. 29, this embodiment has four insert members 216 with the insert members 216 being arranged in stacks of two. One of the stacks of two insert members 216 is spaced from the other stack of two insert members by the gap 260, which extends longitudinally between the stacks of insert members 216. Advantageously, this embodiment provides direct contact between a significant portion of the inside edges (i.e., the edges that define the recess 254) of the first and second bipolar plates 212, 214 and three of the four peripheral edges of each of the insert members 216.

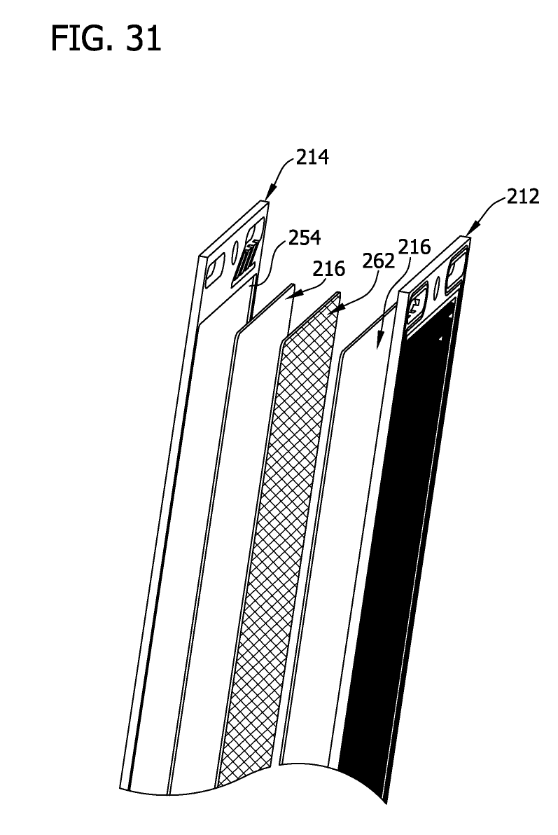

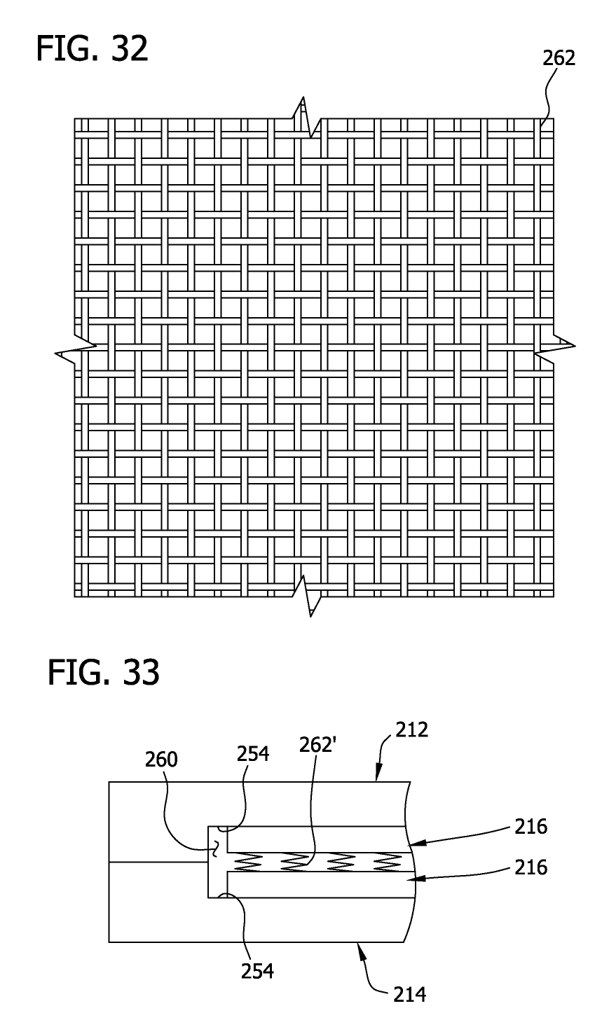

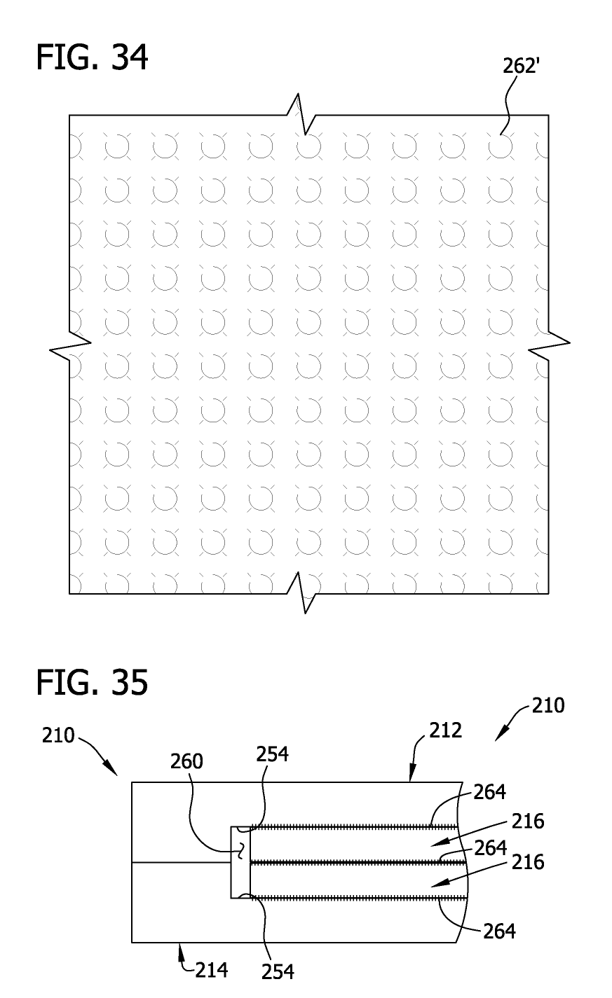

FIGS. 30 and 31 illustrate other configurations of the bipolar plate assembly 210 of FIG. 28. That is, the bipolar plate assembly 210 includes two insert members 216 that are spaced from the inner edges of the first and second bipolar plates 212, 214 by the peripheral gap 260. In the configuration illustrated in FIGS. 30 and 31, however, a spacer 262 (broadly, “a second adjustment member”) is disposed between the two insert members 216. The spacer 262 can be provided to accommodate manufacturing tolerances in the thickness of either of the insert members 216 and/or the thickness in the first and second bipolar plates 212, 214. For example, if one or both of the insert members 216 were manufactured too thin, the spacer 262 can be placed between the insert members to accommodate for the discrepancy in thickness and thereby hold the insert members into direct face-to-face contact with the respective first and second bipolar plate 212, 214. In one suitable embodiment, the spacer 262 is sufficiently electrical and thermally conductive. One such suitable spacer 262, which is illustrated in FIGS. 31 and 32, is a woven metal mesh. In use, the woven metal mesh will cause the surfaces of the insert member 216 that are in contact with the woven metal mesh to flow (or otherwise deform) into the openings in the woven metal mesh. As a result of the intimate connection between the woven metal mesh and the insert members 216, thermal energy and electrical power can readily move between the insert members through the woven metal mesh. FIGS. 33 and 34 illustrate another suitable embodiment of a spacer 262′. In this embodiment, the spacer 262′ comprises a suitable material (e.g., a graphite sheet) that has been embossed to create hills and valleys in the material. It is contemplated that in one suitable embodiment the spacer 262′ can be formed integral with the insert member 216. In such an embodiment, one or more sides of the insert member 216 can be embossed. It is understood, that the spacer 262, 262′ can be formed from any suitable material.

In another configuration of the bipolar plate assembly 210, a conductive filler material 264 (broadly, “a third adjustment member”) can be used to accommodate manufacturing tolerances in the thickness of either of the insert members 216 and/or the thickness in the first and second bipolar plates 212, 214. As seen in FIG. 35, the conductive filler material 264 can be disposed between the two insert members 216 and/or between one of the insert members and the respective one of the first and second bipolar plate 212, 214. In the illustrated embodiment, for example, the conductive filler 264 is disposed between the two insert members 216, between the upper insert member (as viewed in FIG. 35) and the first bipolar plate 212, and between the lower insert member and the second bipolar plate 214. The conductive filler 264 can be formed from, for example, low density graphite, conductive adhesives and conductive pastes. It is understood that any suitable material can be used for the conductive filler 264.

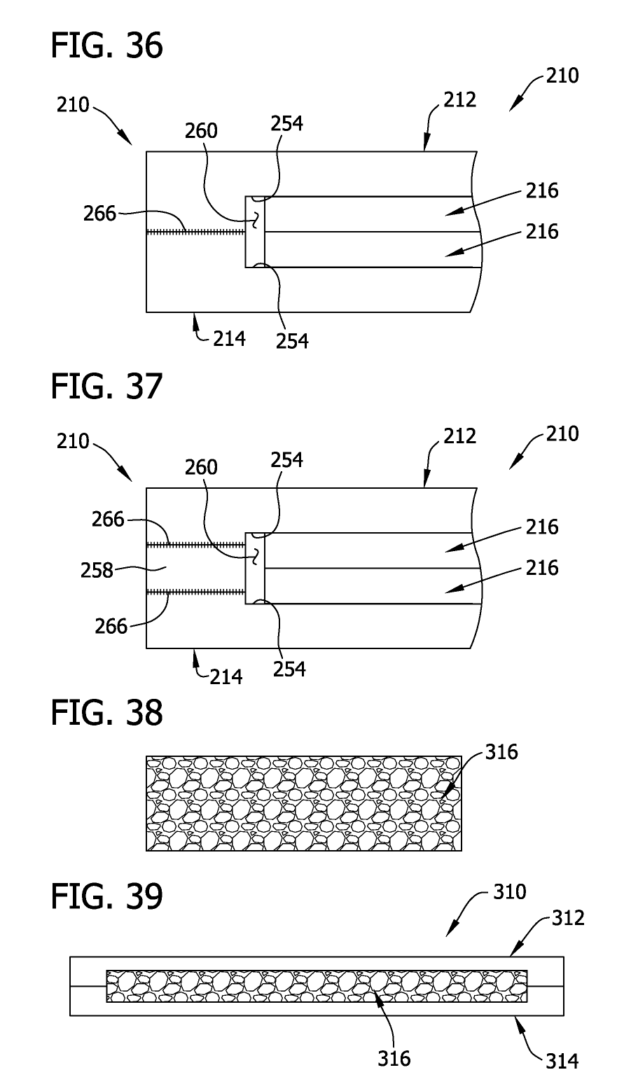

FIG. 36 illustrates yet another suitable way to facilitate intimate contact between the insert members 216 and the first and second bipolar plates 212, 214 of the bipolar plate assembly 210. In this configuration, a relatively thin layer of elastomeric filler 266 (broadly, “a fourth adjustment member”) is applied to the portion of the inner surface of the first and/or second bipolar plate 212, 214 that contacts the other one of the first and second bipolar plate. As a result, the elastomeric filler 266 provides a compliant seal between the first and second bipolar plates 212, 214. The compliance of the elastomeric filler accommodates manufacturing tolerance with respect to the thickness of the insert member 216 and/or the first and second bipolar plates 212, 214. More specifically, the elastomeric filler 266 deflects (i.e., compresses) when a compressive force is applied to the first and second bipolar plates 212, 214 during the assembling of the bipolar plate assembly 210. In one suitable embodiment, the elastomeric filler 266 will sufficiently compress until the insert member 216 is in direct face-to-face contact with both the first and second bipolar plates 212, 214.

FIG. 37 is a cross-section of yet another configuration of the bipolar plate assembly 210 that is similar to the configuration illustrated in FIG. 27. In this configuration, however, a thin layer of the elastomeric filler 266 is applied between the shim 258 and the inner surfaces of the first and second bipolar plates 212, 214 that are in direct contact with the shim. It is understood that the elastomeric filler 266 can be applied between the shim 258 and only one of the first and second bipolar plates 212, 214.

FIGS. 38 and 39 illustrate another embodiment of a bipolar plate assembly for use in a fuel cell, which is generally indicated at 310. As illustrated in FIG. 39, the bipolar plate assembly 310 comprises a first bipolar plate 312, a second bipolar plate 314, and a compressible insert member 316 (broadly, “a fifth adjustment member”) disposed between the first and second bipolar plates. The first and second bipolar plates 312, 314 and the insert member 316 are indicated generally by their respective reference numbers in the accompany drawings. The first and second bipolar plates 312, 314 of this embodiment are substantially the same as the first and second bipolar plates 12, 14 of FIGS. 1-10 and, as a result, will not be described in detail.

The insert member 316 of this embodiment is formed from a suitably compressible material. As a result, the insert member 316, which is illustrated in FIG. 38 in an uncompressed configuration, can be compressed between the first and second bipolar plates 312, 314. The insert member 316 is illustrated in FIG. 39 in its compressed configuration. The compressible insert 316 facilitates intimate contact between the first and second bipolar plates 312, 314.

Suitably, the in-plane electrical conductivity of the compressible insert 316 in its compressed configuration would be greater than 100 S/cm, more suitably greater than 500 S/cm, even more suitably greater than 1,000 S/cm, and most suitably greater than 2,000 S/cm while the through-plane electrical conductivity of the compressible insert in its compressed configuration would suitably be less than 50 S/cm, more suitably less than 40 S/cm, even more suitably less than 30 S/cm, less than 20 S/cm, less than 15 S/cm, and most suitably less than 10 S/cm. Suitably the through-plane thermal conductivity of the compressible insert 316 in its compressed configuration would be less than 20 W/mK, more suitably less than 15 W/mK, even more suitably less than 10 W/mK, less than 5 W/mK, and most suitably less than 3 W/mK while the in-plane thermal conductivity of the compressible insert in its compressed configuration would suitably be greater than 100 W/mK, more suitably greater than 200 W/mK, even more suitably greater than 300 W/mK, greater than 400 W/mK, and most suitably greater than 500 W/mK.

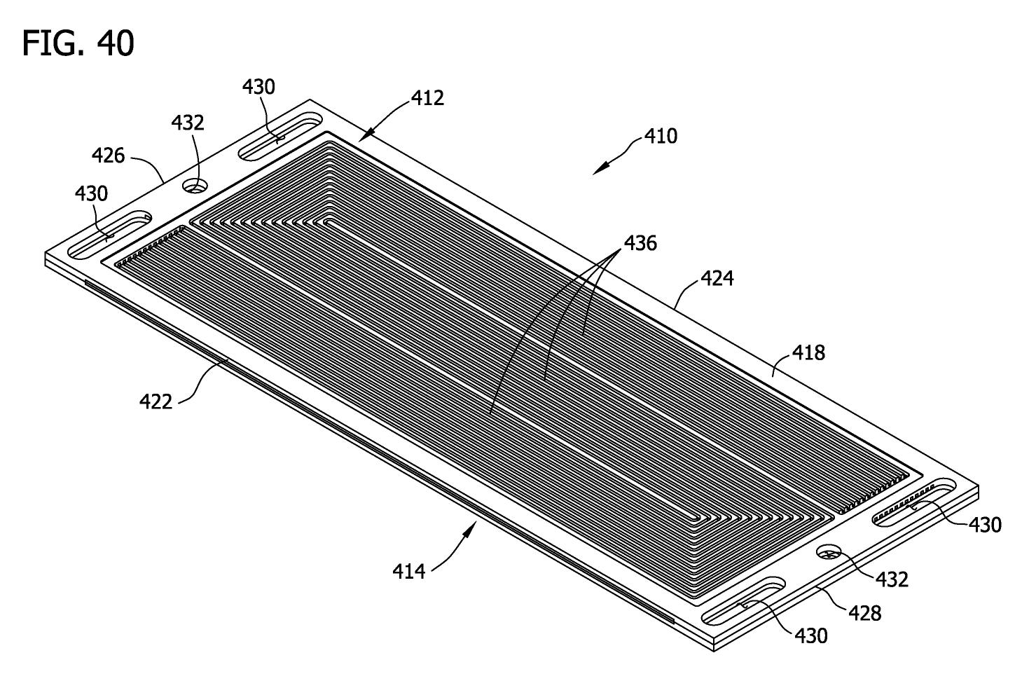

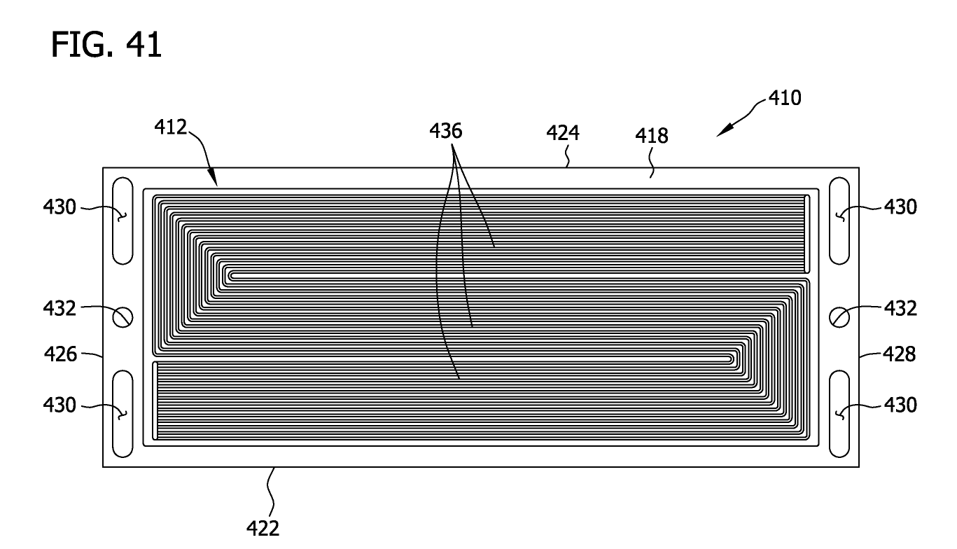

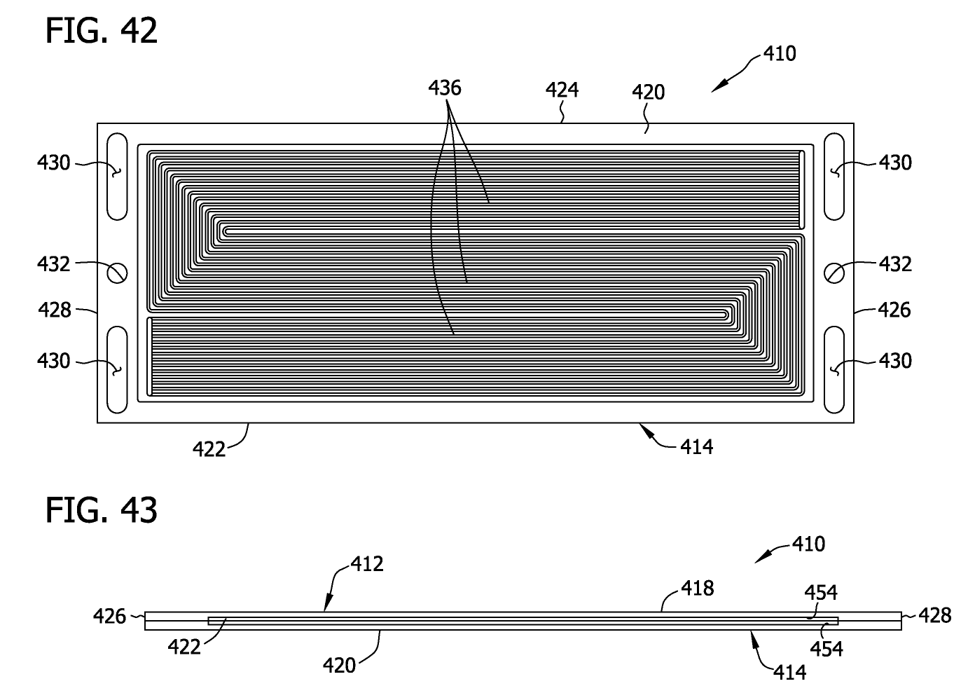

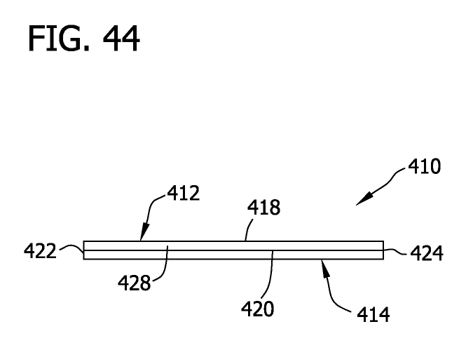

FIGS. 40-45 illustrate yet another embodiment of a bipolar plate assembly for use in a fuel cell, which is generally indicated at 410. As illustrated, the bipolar plate assembly 410 comprises a first bipolar plate 412, a second bipolar plate 414, and at least one insert member 416 disposed between the first and second bipolar plates. The first and second bipolar plates 412, 414 and the insert member 416 are indicated generally by their respective reference numbers in the accompany drawings. In the illustrated embodiment, the bipolar plate assembly 410 has a generally rectangular box shape (i.e., a right cuboid). Accordingly, the illustrated bipolar plate assembly 410 has six generally rectangular faces. More specifically, the bipolar plate assembly 410 has a pair of opposed primary faces (i.e., a front face 418 and a back face 420), a pair of longitudinal side faces 422, 424, and a pair of lateral side faces 426, 428. It is understood, however, that the bipolar plate assembly 410 can have any suitable shape.

The bipolar plate assembly 410 includes four apertures 430 for allowing fluid (gas and/or liquid) to pass through the bipolar plate assembly. As seen in FIGS. 40-43, each of the apertures 430 extends through the primary faces 418, 420 adjacent respective corners of the bipolar plate assembly 410. It is understood that the bipolar plate assembly 410 can have more or fewer apertures 430 and that the apertures can be disposed at locations different than those illustrated in FIGS. 40-43. In the illustrated embodiment, each of the apertures 430 has a generally racetrack shape but it is understood that the apertures can have any suitable shape (i.e., circle, rectangular, elliptical). The bipolar plate assembly 410 also includes a pair of generally circular openings 432 for allowing a dowel (or tie rod) to extend through the bipolar plate assembly. While the openings 432 in the illustrated embodiment are generally circular, it is understood that the openings 432 can be any suitable shape (i.e., square, elliptical, triangular). It is also understood that in some embodiments of the bipolar plate assembly 410, the openings 432 can be omitted.

Each of the primary faces 418, 420 of the bipolar plate assembly 410 has a plurality of channels 436 for distributing fluid across the respective primary face. In the illustrated embodiment, the channels 436 on the front primary face 418 are fluidly connected to two of the apertures 430 and the channels 436 on the back primary face 420 are fluidly connected to the other two apertures 430. As a result, one of the apertures 430 acts as an inlet for the channels 436 on one of the primary faces 418, 420 and the other aperture in fluid communication with the same channel acts as an outlet. The illustrated channels 436 define a serpentine pathway for the fluid as the fluid flows from the aperture 430 defining the inlet to the aperture defining the respective outlet. It is understood that the channels 436 can have different configurations than the configuration illustrated in FIGS. 40-45. For example, the channels 436 can define a generally linear pathway for the fluid as the fluid flows from the aperture 430 defining the inlet to the aperture defining the respective outlet. In such an embodiment, the channels 436 can extend longitudinally, laterally or diagonally (i.e., at angles relative to the longitudinal and lateral axes of the bipolar plate assembly 410). It is understood that the primary faces 418, 420 can have more or fewer channels than those illustrated in the accompanying drawings. It is also understood that the primary faces 418, 420 can have a different number of channels. That is, for example, the front primary face 418 can have more or fewer channels than the back primary face 420.

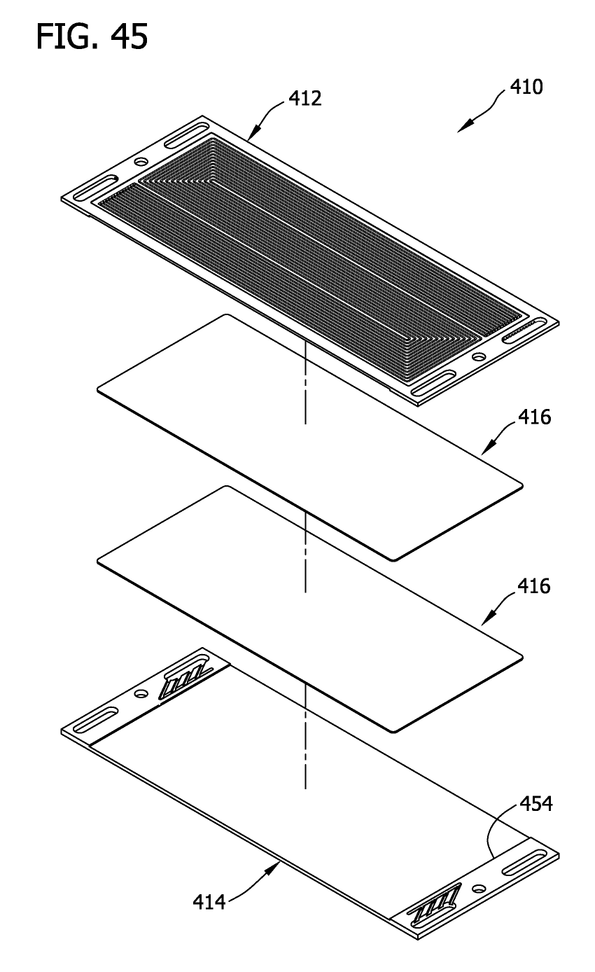

In this embodiment of the bipolar plate assembly 410, the first and second bipolar plates 412, 414 include recesses 454 formed in their inner surfaces. The recess 454 in the second bipolar plate 414 is illustrated in FIG. 45. The recesses 454 in the first and second bipolar plates 412, 414 are sized and shaped for cooperatively receiving the insert members 416. The insert members 416 of this embodiment, which are generally rectangular uniform plate, are illustrated in FIG. 45. In this embodiment, the insert members 416 are free of apertures and, as a result, no portion of the insert members 416 defines any of the fluid apertures 430 in bipolar plate assembly 410. In fact, the insert members 416 are spaced from the apertures 430 thereby inhibiting any fluid flowing through the fuel cell from contacting the insert members.

In one suitable embodiment, adhesive can be used to bond the first and second bipolar plates 412, 414 together. It is understood that the insert members 416 can be bonded together and/or bonded to one or both of the first and second bipolar plates 412, 414 or that the insert members can be free from bonding. As seen in FIG. 43, the insert members 416 are captured within the recesses 454 in the first and second bipolar plates 412, 414 such that the longitudinal edges of the insert member define a portion of the longitudinal side faces 422, 424 of the bipolar plate assembly 410. The adhesive, which can be either electrically conductive or non-conductive, can be applied to one of or both the first and second bipolar plates 412, 414.

During use, the channels 436 are designed to distribute reactant evenly across the fuel cell's membrane electrode assembly (MEA). Accordingly, the area of the primary faces 418, 420 of the bipolar plate assembly comprising the channels 436 roughly defines the fuel cell's “active-area”. The active-area is the region where chemical reactions take place during operation of the fuel cell. As a result, the active area is the region of the fuel cell where heat from the reaction originates. The geometry of the active-area (e.g., generally rectangular in the illustrated embodiment) is designed so that the fuel cell will produce the rated power.

As explained in more detail below, the illustrated bipolar plate assembly 410 has an in-plane thermal conductivity sufficient to conduct the heat from the active area to at least one of the longitudinal side faces 422, 424 and the lateral side faces 426, 428. In one suitable embodiment, the bipolar plate assembly 410 has an in-plane thermal conductivity sufficient to conduct the heat from the active area to both of the longitudinal side faces 422, 424 of the bipolar plate assembly 410. More specifically, the insert members 416, which define a portion of the longitudinal side faces 422, 424 of the bipolar plate assembly 410, have an in-plane thermal conductivity sufficient to conduct the heat from the active area to both of the longitudinal side faces 422, 424. As a result, a fuel cell stack comprising a plurality of the illustrated bipolar plate assemblies 410 can be cooled by mating a heat exchanger to the longitudinal side faces 422, 424 of each of the bipolar plate assemblies defining the stack. In one suitable embodiment, the heat exchanger is a cold plate. Moreover, the in-plane thermal conductivity of each of the bipolar plate assemblies 410 within the fuel cell is sufficiently high such that the temperature difference between any two points on the MEA is minimal. A relatively uniform temperature distribution across the MEA within a desired temperature range enhances both performance and durability of the fuel cell.

In the illustrated embodiment, the first and second bipolar plates 412, 414 are made from the same material. However, the insert members 416 are made from a material that is different than the first and second bipolar plates 412, 414. In one suitable embodiment, the first and second bipolar plates 412, 414 are made from a material that is resistant to the fuel cell environment (e.g., temperature, electro-chemistry, reactants, acids), electrically conductive, gas impermeable (e.g., hydrogen impermeable) and has a relative low in-plane thermal conductivity (˜40 W/mK).

For example, the first and second bipolar plates 412, 414 can be relatively inexpensive, moldable composite comprising graphite filler in a polymer resin. Examples include moldable graphite/thermoset phenolic composites such as BMC 955 available from Bulk Molding Compounds, Inc. of West Chicago, Ill., U.S.A. and BBP4 available from SGL Carbon GmbH of Wiesbaden, Germany. Other suitable materials include, for example, moldable graphite/thermoplastic composites, such as BMA5 and PPG86 also available from SGL Carbon GmbH of Wiesbaden, Germany.

In one suitable embodiment, the material of the first and second bipolar plates 412, 414 has the tensile strength greater than 30 MPa, more suitably greater than 35 MPa, even more suitably greater than 40 MPa, and most suitably greater than 45 MPa. The flexural strength of the suitable material for the first and second bipolar plates 412, 414 would be greater than 30 MPa, more suitably greater than 35 MPa, even more suitably greater than 40 MPa, greater than 45 MPa, and most suitably greater than 50 MPa. The suitable material for the first and second bipolar plates 412, 414 would also have both a flexural modulus and a tensile modulus greater than 10 GPa, more suitably greater than 15 GPa, and even more suitably greater than 20 GPa.

Suitably, the in-plane electrical conductivity of the material would be less than 300 S/cm, more suitably less than 200 S/cm, even more suitably less than 100 S/cm, less than 80 S/cm, and most suitably less than 60 S/cm while the through-plane electrical conductivity of the material would suitably be greater than 5 S/cm, more suitably greater than 10 S/cm, even more suitably greater than 20 S/cm, greater than 30 S/cm, greater than 40 S/cm, and most suitably greater than 50 S/cm. Suitably, the in-plane thermal conductivity of the material would be less than 60 W/mK, more suitably less than 50 W/mK, even more suitably less than 40 W/mK, less than 30 W/mK, less than 20 W/mK, and most suitably less than 10 W/mK while the through-plane thermal conductivity of the material would suitably be greater than 5 W/mK, more suitably greater than 10 W/mK, even more suitably greater than 15 W/mK, greater than 20 W/mK, and most suitably greater than 25 W/mK.

Suitably, the through-plane thermal expansion of the material would be less than 90 ppm/° C., more suitably less than 60 ppm/° C., even more suitably less than 30 ppm/° C., and most suitably less than 25 ppm/° C. while the in-plane thermal expansion of the material would suitably be greater than 0 ppm/° C., more suitably greater than 1 ppm/° C., even more suitably greater than 5 ppm/° C., greater than 10 ppm/° C., greater than 15 ppm/° C., greater than 20 ppm/° C., and most suitably greater than 25 ppm/° C. The density of the material of the first and second bipolar plates 212, 214 would suitably be greater than 1.5 g/cc, greater than 1.6 g/cc, greater than 1.7 g/cc, greater than 1.8 g/cc, greater than 1.9 g/cc, and more suitably greater than 2.0 g/cc.

The insert members 416, which are illustrated in FIG. 45, has a relatively high thermal conductivity to facilitate heat removal from the fuel cell. In one suitable embodiment, the insert members 416 are made from a material that is resistant to the fuel cell environment (e.g., temperature, electro-chemistry, reactants, acids), electrically conductive, gas impermeable (e.g., hydrogen impermeable) and has a relatively high in-plane thermal conductivity (500 W/mK). However, the material of the insert members 416 can be less resistance to acid, products and reactants and have an increased permeability to hydrogen as compared to the material of the bipolar plates 412, 414. Since the material of the insert members 416 is more costly compared to the material of the bipolar plates, it is desirable to minimize the insert member material.

Material suitable for use as the insert members 416 include, but are not limited to, a graphite foil comprising expanded natural or synthetic graphite that has been expanded or exfoliated and then recompressed. Examples include SPREADERSHIELD and GRAFOIL available from Graftech International Holdings of Parma, Ohio, U.S.A. and SIGRAFLEX available from SGL Carbon GmbH, of Wiesbaden, Germany. Other suitable materials include, for example, metal clad graphite foils, polymer impregnated graphite foils, other forms of carbon, including CVD carbon and carbon-carbon composites, silicon carbide, and high thermal conductivity metals or alloys containing aluminum, beryllium, copper, gold, magnesium, silver and tungsten.

In one suitable embodiment, the material used for the insert members 416 has both a flexural strength and a tensile strength less than 50 MPa, more suitably less than 40 MPa, even more suitably less than 30 MPa, less than 20 MPa, and most suitably less than 10 MPa. The material suitable for the insert member 216 would also have both a flexural modulus and a tensile modulus less than 20 GPa, more suitably less than 15 GPa, even more suitably less than 10 GPa, and most suitably less than 5 GPa.

Suitably, the in-plane electrical conductivity of the material would be greater than 100 S/cm, more suitably greater than 500 S/cm, even more suitably greater than 1,000 S/cm, and most suitably greater than 2,000 S/cm while the through-plane electrical conductivity of the material would suitably be less than 50 S/cm, more suitably less than 40 S/cm, even more suitably less than 30 S/cm, less than 20 S/cm, less than 15 S/cm, and most suitably less than 10 S/cm. Suitably, the through-plane thermal conductivity of the material would be less than 20 W/mK, more suitably less than 15 W/mK, even more suitably less than 10 W/mK, less than 5 W/mK, and most suitably less than 3 W/mK while the in-plane thermal conductivity of the material would suitably be greater than 100 W/mK, more suitably greater than 200 W/mK, even more suitably greater than 300 W/mK, greater than 400 W/mK, and most suitably greater than 500 W/mK.

Suitably the through-plane thermal expansion of the material would be less than 90 ppm/° C., more suitably less than 60 ppm/° C., even more suitably less than 30 ppm/° C., and most suitably less than 25 ppm/° C. and the in-plane thermal expansion of the material would suitably be less than 5 ppm/° C., more suitably less than 3 ppm/° C., even more suitably less than 1 ppm/° C., less than 0 ppm/° C., and most suitably less than −0.3 ppm/° C. The density of the material of the insert member 16 would suitably be less than 1.9 g/cc, less than 1.8 g/cc, less than 1.7 g/cc, less than 1.6 g/cc, less than 1.5 g/cc, and more suitably less than 1.4 g/cc.

As mentioned above, the illustrated bipolar plate assembly 410 has an in-plane thermal conductivity sufficient to conduct heat from the active area to both of the longitudinal side faces 422, 424 of the bipolar plate assembly 410 where it can be transferred to a suitable heat exchanger. More specifically, as seen in FIG. 45, the insert members 416 are positioned so they general correspond to the active areas of the bipolar plate assembly 410 (i.e., the areas of the primary faces 418, 420 comprising the channels 436). As a result, heat created at the active areas during operation of the fuel cell is transferred to the insert members 416. Because of the relatively high in-plane thermal conductively of the insert member material 416, heat is transferred relatively quickly and uniformly throughout the insert members. In this embodiment, heat is conducted out of the longitudinal side faces 422, 424 of the bipolar plate assembly 410, which are defined in part by the insert members 416. As a result, heat can be transferred directly from the insert members 416 to the heat exchanger.

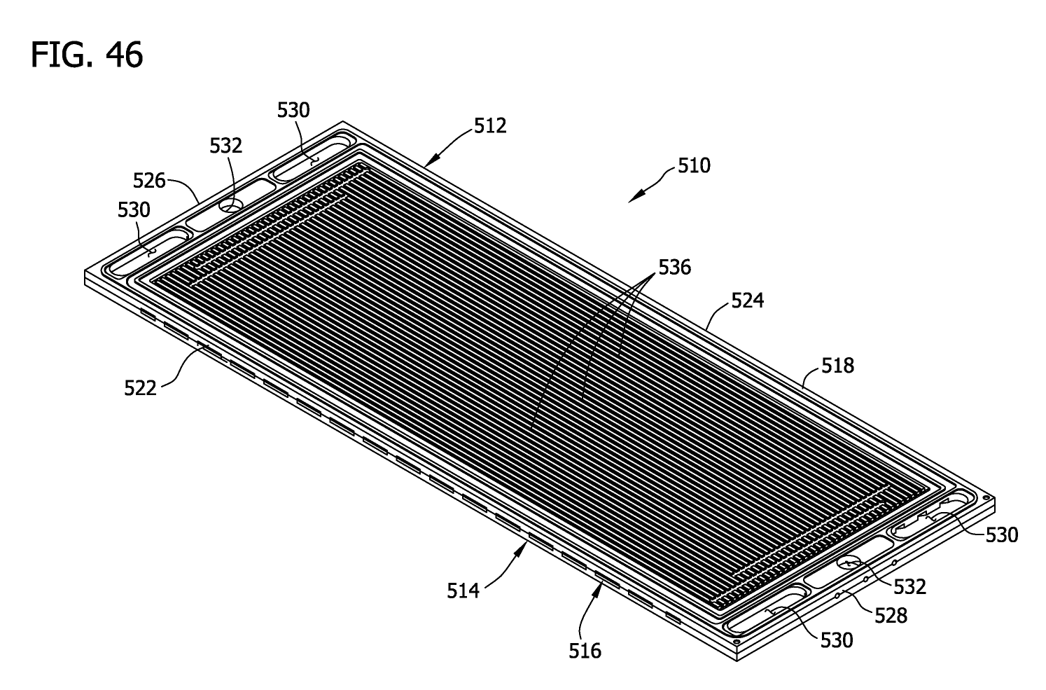

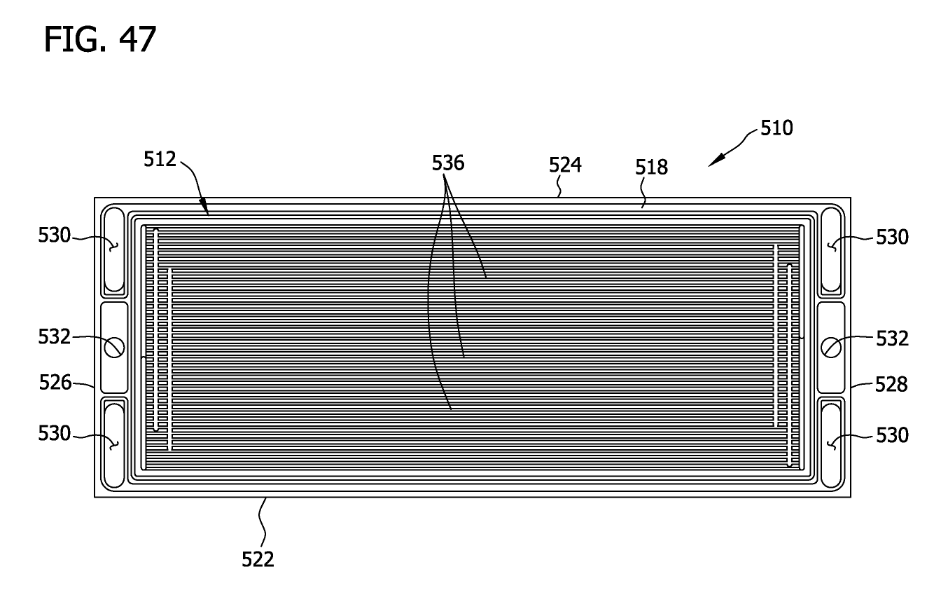

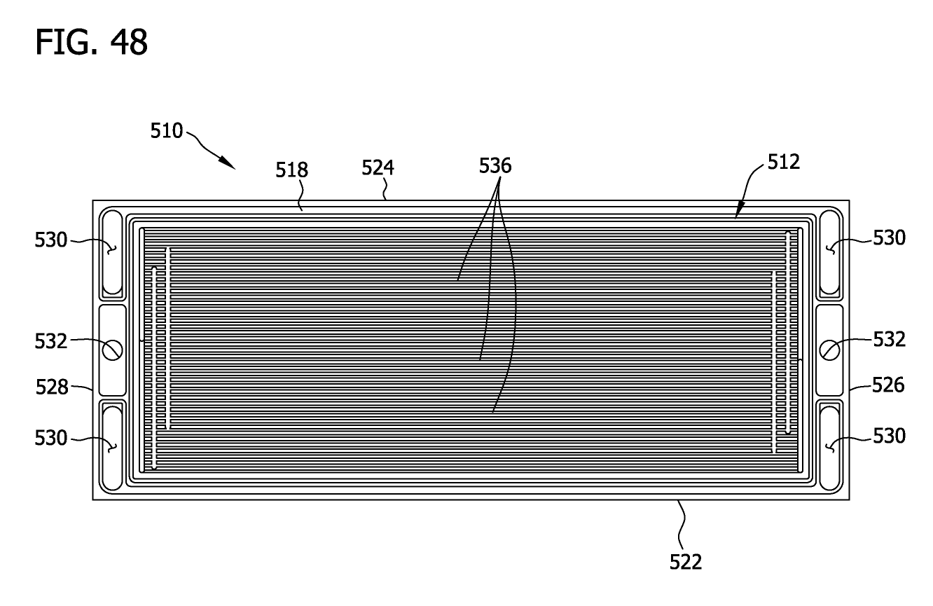

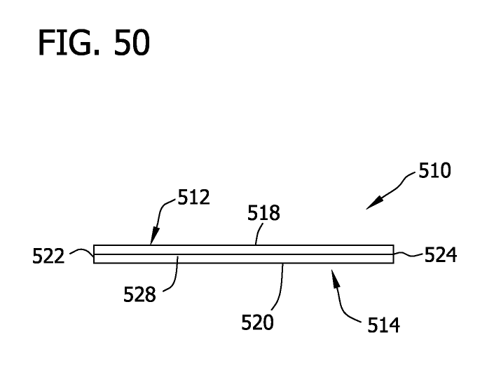

FIGS. 46-51 illustrate yet another embodiment of a bipolar plate assembly for use in a fuel cell, which is generally indicated at 510. As illustrated, the bipolar plate assembly 510 comprises a first bipolar plate 512, a second bipolar plate 514, and at least one insert member 516 disposed between the first and second bipolar plates. The first and second bipolar plates 512, 514 and the insert member 516 are indicated generally by their respective reference numbers in the accompany drawings. In the illustrated embodiment, the bipolar plate assembly 510 has a generally rectangular box shape (i.e., a right cuboid). Accordingly, the illustrated bipolar plate assembly 510 has six generally rectangular faces. More specifically, the bipolar plate assembly 510 has a pair of opposed primary faces (i.e., a front face 518 and a back face 520), a pair of longitudinal side faces 522, 524, and a pair of lateral side faces 526, 528. It is understood, however, that the bipolar plate assembly 510 can have any suitable shape.

The bipolar plate assembly 510 includes four apertures 530 for allowing fluid (gas and/or liquid) to pass through the bipolar plate assembly. As seen in FIGS. 46-48, each of the apertures 530 extends through the primary faces 518, 520 adjacent respective corners of the bipolar plate assembly 510. It is understood that the bipolar plate assembly 510 can have more or fewer apertures 530 and that the apertures can be disposed at locations different than those illustrated in FIGS. 46-48. In the illustrated embodiment, each of the apertures 530 has a generally racetrack shape but it is understood that the apertures can have any suitable shape (i.e., circle, rectangular, elliptical). The bipolar plate assembly 510 also includes a pair of generally circular openings 532 for allowing a dowel (or tie rod) to extend through the bipolar plate assembly. While the openings 532 in the illustrated embodiment are generally circular, it is understood that the openings 532 can be any suitable shape (i.e., square, elliptical, triangular). It is also understood that in some embodiments of the bipolar plate assembly 510, the openings 532 can be omitted.

Each of the primary faces 518, 520 of the bipolar plate assembly 510 has a plurality of channels 536 for distributing fluid across the respective primary face. In the illustrated embodiment, the channels 536 on the front primary face 518 are fluidly connected to two of the apertures 530 and the channels 536 on the back primary face 520 are fluidly connected to the other two apertures 530. As a result, one of the apertures 530 acts as an inlet for the channels 536 on one of the primary faces 518, 520 and the other aperture in fluid communication with the same channel acts as an outlet. The illustrated channels 536 define a generally linear pathway for the fluid as the fluid flows from the aperture 530 defining the inlet to the aperture defining the respective outlet. In such an embodiment, the channels 536 can extend longitudinally, laterally or diagonally (i.e., at angles relative to the longitudinal and lateral axes of the bipolar plate assembly 510). It is understood that the primary faces 518, 520 can have more or fewer channels than those illustrated in the accompanying drawings. It is also understood that the primary faces 518, 520 can have a different number of channels. That is, for example, the front primary face 518 can have more or fewer channels than the back primary face 520.

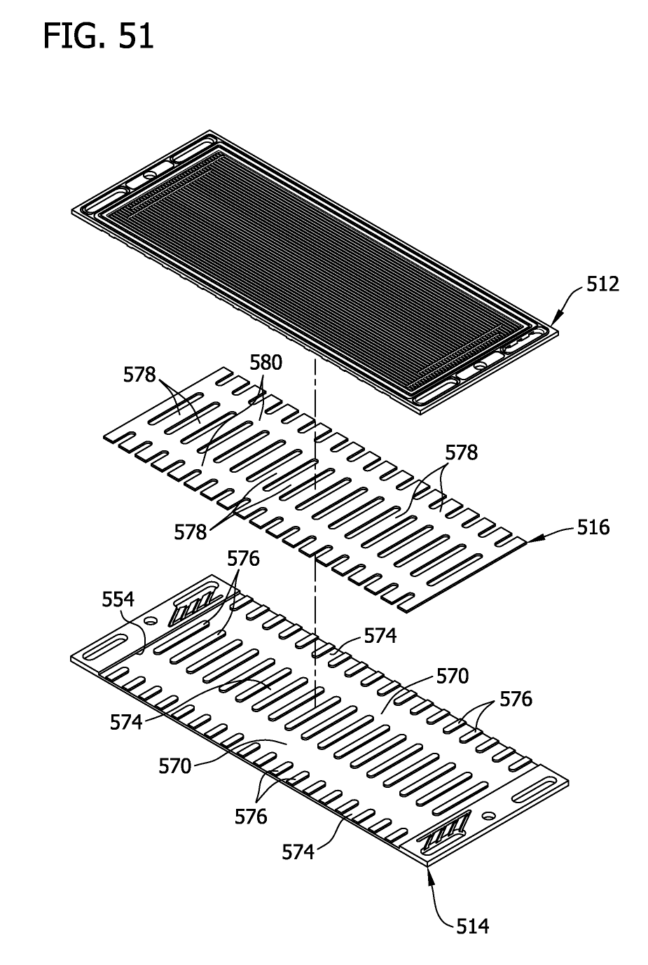

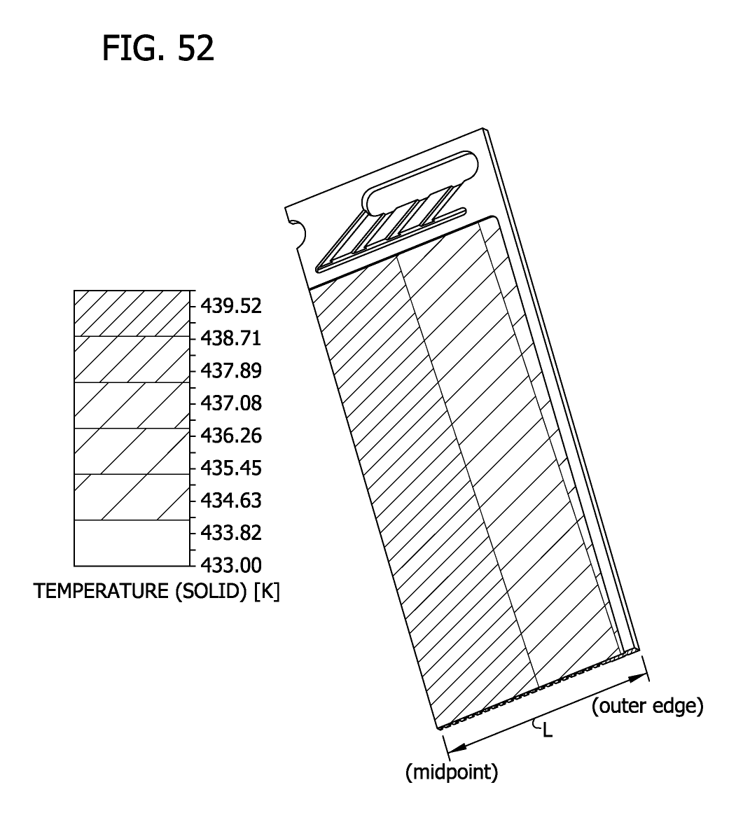

In this embodiment of the bipolar plate assembly 510, the first and second bipolar plates 512, 514 include recesses 554 formed in their inner surfaces. The recesses 554 in the inner surfaces of the first and second bipolar plates 512, 514 (the recess in the inner surface of the second bipolar plate being seen in FIG. 51) include a plurality of lateral segments 574 and a pair of spaced-apart longitudinal segments 570 that intersect the lateral segments. As seen in FIG. 51, the lateral segments 574 of the recess are spaced by a plurality of upwardly extending pillars 576.

With references still to FIG. 51, the recesses 554 in the first and second bipolar plates 512, 514 are sized and shaped for cooperatively receiving the insert member 516. Thus, the size and shape of the insert member 516 generally corresponds to the size and shape of the recesses 554. More specifically, the insert member 516 of this embodiment includes a plurality of lateral segments 578 and a pair of spaced-apart longitudinal segments 580 that intersect the lateral segments that correspond to the lateral segments 574 and longitudinal segments 570 of the recesses 554 formed in the first and second bipolar plates 512, 514. It is understood that the insert member 516 and first and/or second bipolar plates 512, 514 can have more or fewer longitudinal segments 570, 580 and/or lateral segments 574, 578 than those illustrated and described herein. It is also understood that the longitudinal segments 570, 580 and/or lateral segments 574, 578 can be other than linear as seen in FIG. 51.

In one suitable embodiment, adhesive can be used to bond the first and second bipolar plates 512, 514 together. It is understood that the insert member 516 can be bonded to one or both of the first and second bipolar plates 512, 514 or that the insert member can be free from bonding. As seen in FIG. 51, the insert member 516 is captured within the recesses in the first and second bipolar plates 512, 514 such that the outer edges of the lateral segments of the insert member define a portion of the longitudinal side faces 522, 524 of the bipolar plate assembly 510. The adhesive, which can be either electrically conductive or non-conductive, can be applied to one of or both the first and second bipolar plates 512, 514.

During use, the channels 536 are designed to distribute reactant evenly across the fuel cell's membrane electrode assembly (MEA). Accordingly, the area of the primary faces 518, 520 of the bipolar plate assembly comprising the channels 536 roughly defines the fuel cell's “active-area”. The active-area is the region where chemical reactions take place during operation of the fuel cell. As a result, the active area is the region of the fuel cell where heat from the reaction originates. The geometry of the active-area (e.g., generally rectangular in the illustrated embodiment) is designed so that the fuel cell will produce the rated power.

As explained in more detail below, the illustrated bipolar plate assembly 510 has an in-plane thermal conductivity sufficient to conduct the heat from the active area to at least one of the longitudinal side faces 522, 524 and the lateral side faces 526, 528. In one suitable embodiment, the bipolar plate assembly 510 has an in-plane thermal conductivity sufficient to conduct the heat from the active area to both of the longitudinal side faces 522, 524 of the bipolar plate assembly 510. More specifically, the insert member 516, which defines a portion of the longitudinal side faces 522, 524 of the bipolar plate assembly 510, has an in-plane thermal conductivity sufficient to conduct the heat from the active area to both of the longitudinal side faces 522, 524. As a result, a fuel cell stack comprising a plurality of the illustrated bipolar plate assemblies 510 can be cooled by mating a heat exchanger to the longitudinal side faces 522, 524 of each of the bipolar plate assemblies defining the stack. In one suitable embodiment, the heat exchanger is a cold plate. Moreover, the in-plane thermal conductivity of each of the bipolar plate assemblies 510 within the fuel cell is sufficiently high such that the temperature difference between any two points on the MEA is minimal. A relatively uniform temperature distribution across the MEA within a desired temperature range enhances both performance and durability of the fuel cell.

In the illustrated embodiment, the first and second bipolar plates 512, 514 are made from the same material. However, the insert member 516 is made from a material that is different than the first and second bipolar plates 512, 514. In one suitable embodiment, the first and second bipolar plates 512, 514 are made from a material that is resistant to the fuel cell environment (e.g., temperature, electro-chemistry, reactants, acids), electrically conductive, gas impermeable (e.g., hydrogen impermeable) and has a relative low in-plane thermal conductivity (˜40 W/mK).

For example, the first and second bipolar plates 512, 514 can be relatively inexpensive, moldable composite comprising graphite filler in a polymer resin. Examples include moldable graphite/thermoset phenolic composites such as BMC 955 available from Bulk Molding Compounds, Inc. of West Chicago, Ill., U.S.A. and BBP4 available from SGL Carbon GmbH of Wiesbaden, Germany. Other suitable materials include, for example, moldable graphite/thermoplastic composites, such as BMA5 and PPG86 also available from SGL Carbon GmbH of Wiesbaden, Germany.

In one suitable embodiment, the material of the first and second bipolar plates 512, 514 has the tensile strength greater than 30 MPa, more suitably greater than 35 MPa, even more suitably greater than 40 MPa, and most suitably greater than 45 MPa. The flexural strength of the suitable material for the first and second bipolar plates 512, 514 would be greater than 30 MPa, more suitably greater than 35 MPa, even more suitably greater than 40 MPa, greater than 45 MPa, and most suitably greater than 50 MPa. The suitable material for the first and second bipolar plates 512, 514 would also have both a flexural modulus and a tensile modulus greater than 10 GPa, more suitably greater than 15 GPa, and even more suitably greater than 20 GPa.

Suitably, the in-plane electrical conductivity of the material would be less than 300 S/cm, more suitably less than 200 S/cm, even more suitably less than 100 S/cm, less than 80 S/cm, and most suitably less than 60 S/cm while the through-plane electrical conductivity of the material would suitably be greater than 5 S/cm, more suitably greater than 10 S/cm, even more suitably greater than 20 S/cm, greater than 30 S/cm, greater than 40 S/cm, and most suitably greater than 50 S/cm. Suitably, the in-plane thermal conductivity of the material would be less than 60 W/mK, more suitably less than 50 W/mK, even more suitably less than 40 W/mK, less than 30 W/mK, less than 20 W/mK, and most suitably less than 10 W/mK while the through-plane thermal conductivity of the material would suitably be greater than 5 W/mK, more suitably greater than 10 W/mK, even more suitably greater than 15 W/mK, greater than 20 W/mK, and most suitably greater than 25 W/mK.

Suitably the through-plane thermal expansion of the material would be less than 90 ppm/° C., more suitably less than 60 ppm/° C., even more suitably less than 30 ppm/° C., and most suitably less than 25 ppm/° C. while the in-plane thermal expansion of the material would suitably be greater than 0 ppm/° C., more suitably greater than 1 ppm/° C., even more suitably greater than 5 ppm/° C., greater than 10 ppm/° C., greater than 15 ppm/° C., greater than 20 ppm/° C., and most suitably greater than 25 ppm/° C. The density of the material of the first and second bipolar plates 212, 214 would suitably be greater than 1.5 g/cc, greater than 1.6 g/cc, greater than 1.7 g/cc, greater than 1.8 g/cc, greater than 1.9 g/cc, and more suitably greater than 2.0 g/cc.

The insert member 516, which is illustrated in FIG. 51, has a relatively high thermal conductivity to facilitate heat removal from the fuel cell. In one suitable embodiment, the insert member 516 is made from a material that is resistant to the fuel cell environment (e.g., temperature, electro-chemistry, reactants, acids), electrically conductive, gas impermeable (e.g., hydrogen impermeable) and has a relatively high in-plane thermal conductivity (500 W/mK). However, the material of the insert member 516 can be less resistance to acid, products and reactants and have an increased permeability to hydrogen as compared to the material of the bipolar plates 512, 514. Since the material of the insert member 516 is more costly compared to the material of the bipolar plates, it is desirable to minimize the insert member material.

Material suitable for use as the insert member 516 include, but are not limited to, a graphite foil comprising expanded natural or synthetic graphite that has been expanded or exfoliated and then recompressed. Examples include SPREADERSHIELD and GRAFOIL available from Graftech International Holdings of Parma, Ohio, U.S.A. and SIGRAFLEX available from SGL Carbon GmbH, of Wiesbaden, Germany. Other suitable materials include, for example, metal clad graphite foils, polymer impregnated graphite foils, other forms of carbon, including CVD carbon and carbon-carbon composites, silicon carbide, and high thermal conductivity metals or alloys containing aluminum, beryllium, copper, gold, magnesium, silver and tungsten.

In one suitable embodiment, the material used for the insert member 516 has both a flexural strength and a tensile strength less than 50 MPa, more suitably less than 40 MPa, even more suitably less than 30 MPa, less than 20 MPa, and most suitably less than 10 MPa. The material suitable for the insert member 516 would also have both a flexural modulus and a tensile modulus less than 20 GPa, more suitably less than 15 GPa, even more suitably less than 10 GPa, and most suitably less than 5 GPa.

Suitably, the in-plane electrical conductivity of the material would be greater than 100 S/cm, more suitably greater than 500 S/cm, even more suitably greater than 1,000 S/cm, and most suitably greater than 2,000 S/cm while the through-plane electrical conductivity of the material would suitably be less than 50 S/cm, more suitably less than 40 S/cm, even more suitably less than 30 S/cm, less than 20 S/cm, less than 15 S/cm, and most suitably less than 10 S/cm. Suitably the through-plane thermal conductivity of the material would be less than 20 W/mK, more suitably less than 15 W/mK, even more suitably less than 10 W/mK, less than 5 W/mK, and most suitably less than 3 W/mK while the in-plane thermal conductivity of the material would suitably be greater than 100 W/mK, more suitably greater than 200 W/mK, even more suitably greater than 300 W/mK, greater than 400 W/mK, and most suitably greater than 500 W/mK.

Suitably the through-plane thermal expansion of the material would be less than 90 ppm/° C., more suitably less than 60 ppm/° C., even more suitably less than 30 ppm/° C., and most suitably less than 25 ppm/° C. and the in-plane thermal expansion of the material would suitably be less than 5 ppm/° C., more suitably less than 3 ppm/° C., even more suitably less than 1 ppm/° C., less than 0 ppm/° C., and most suitably less than −0.3 ppm/° C. The density of the material of the insert member 16 would suitably be less than 1.9 g/cc, less than 1.8 g/cc, less than 1.7 g/cc, less than 1.6 g/cc, less than 1.5 g/cc, and more suitably less than 1.4 g/cc.

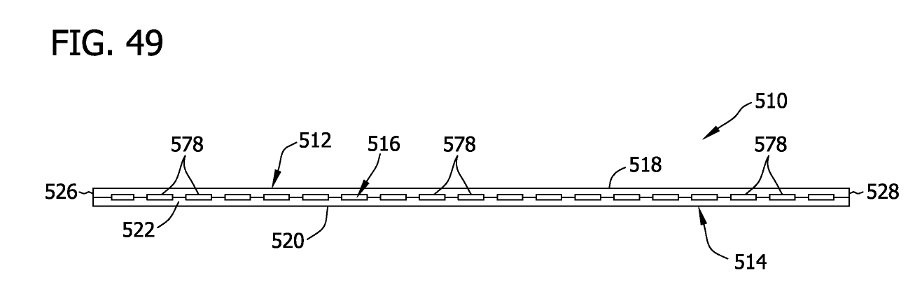

As mentioned above, the illustrated bipolar plate assembly 510 has an in-plane thermal conductivity sufficient to conduct heat from the active area to both of the longitudinal side faces 522, 524 of the bipolar plate assembly 510 where it can be transferred to a suitable heat exchanger. More specifically, as seen in FIG. 51, the insert member 516 is positioned so it generally corresponds to the active areas of the bipolar plate assembly 510 (i.e., the areas of the primary faces 518, 520 comprising the channels 536). As a result, heat created at the active areas during operation of the fuel cell is transferred to the insert member 516. Because of the relatively high in-plane thermal conductively of the insert member material 516, heat is transferred relatively quickly and uniformly throughout the insert member. In this embodiment heat is conducted out of the longitudinal side faces 522, 524 of the bipolar plate assembly 510, which are defined in part by the outer edges of the lateral segments 578 of the insert member 516 (FIG. 49) and in part by the first and second bipolar plates 512, 514. As a result, heat can be transferred directly from the insert member 516 and the first and second bipolar plates 512, 514 to the heat exchanger.

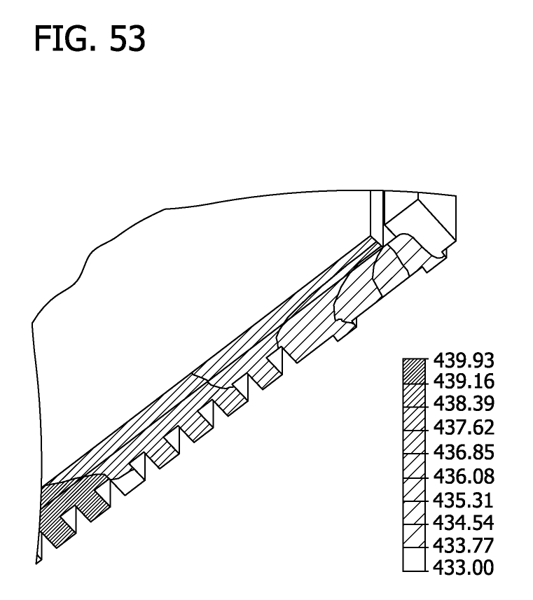

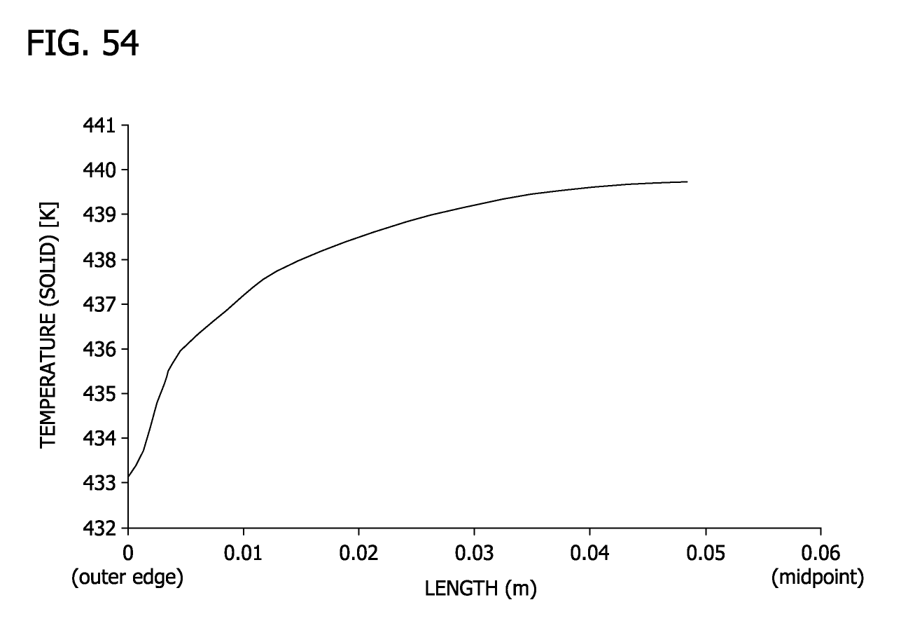

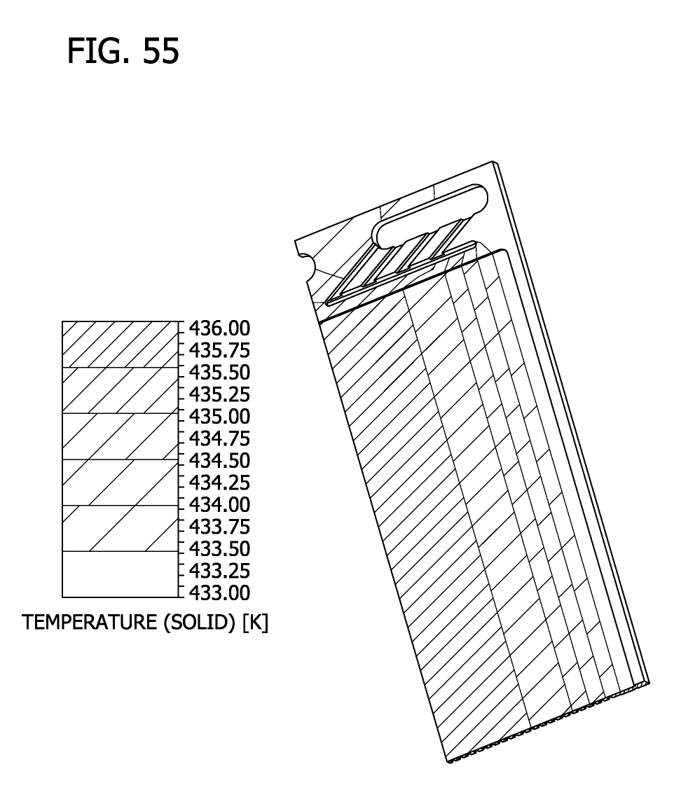

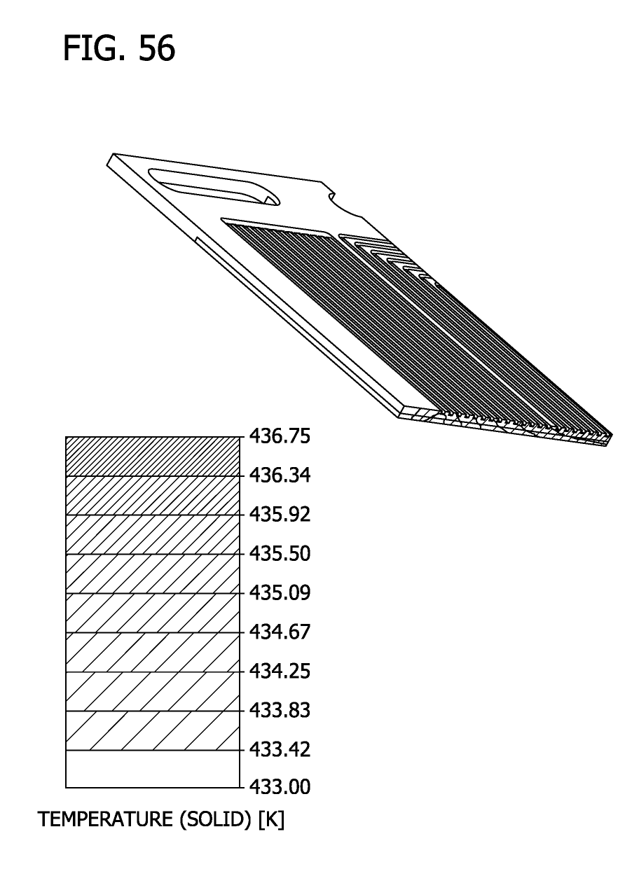

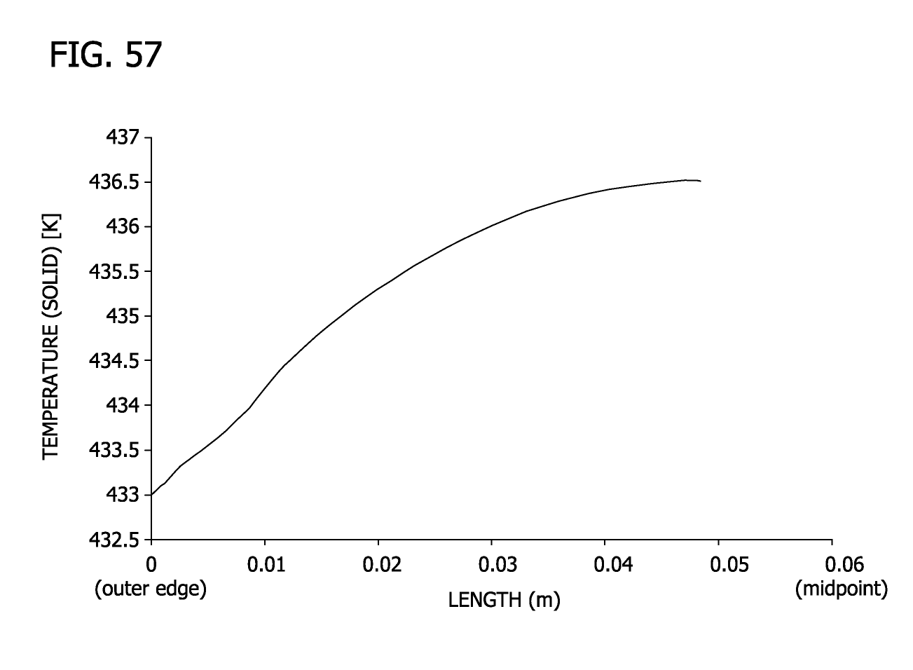

A one-quarter plate computational thermal analysis of the bipolar plate assembly illustrated in FIGS. 14-19 was conducted to determine the temperature distribution under thermal-loading conditions. In this analysis, 5.6 watts of heat power were applied to the active region of the bipolar plate assembly and a constant temperature of 160° C. was applied to one of the longitudinal side faces of the bipolar plate assembly. As depicted in FIGS. 52-54, the analysis predicts a 6.93 K temperature variation from the midplane of the bipolar plate assembly to its longitudinal side face (i.e., across length L as seen in FIG. 52).

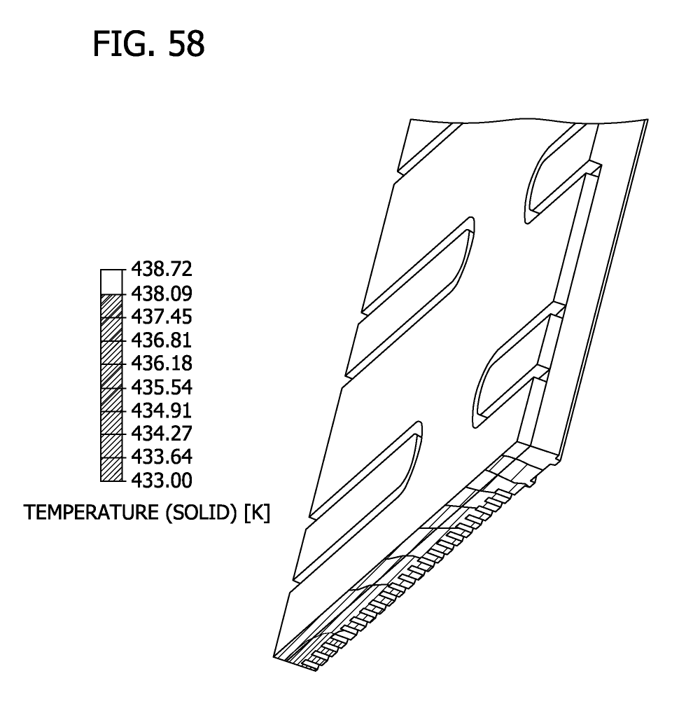

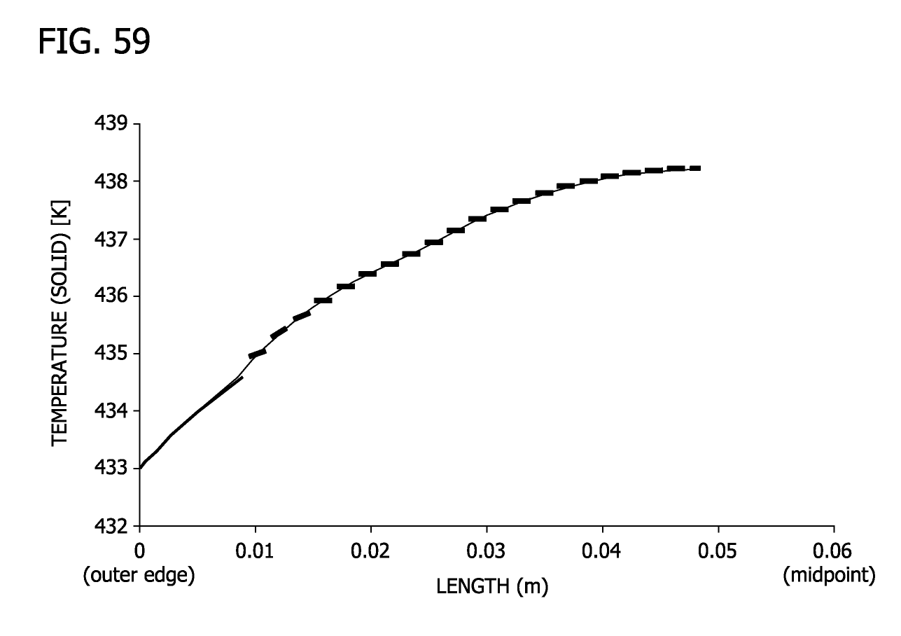

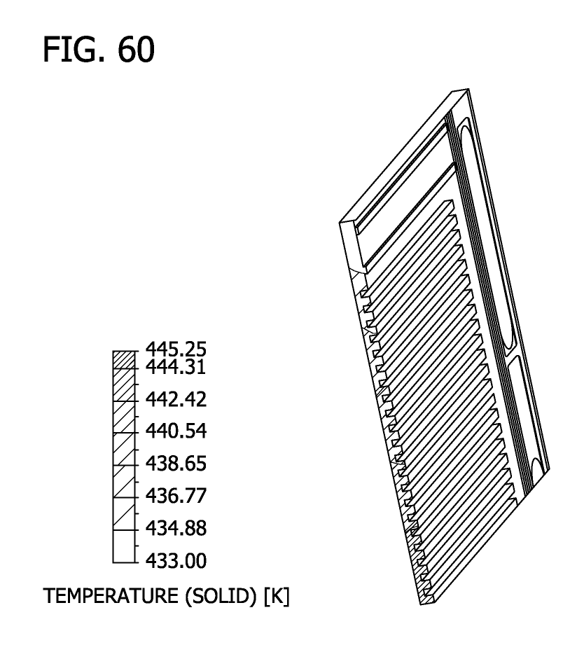

A one-quarter plate computational thermal analysis of the bipolar plate assembly illustrated in FIGS. 46-51 was also conducted to determine the temperature distribution under thermal-loading conditions for this embodiment. The one-quarter plate analysis is employed due to symmetry. In the method, symmetry constraints are placed on the computer model. In the analysis of that model, finite element analysis is employed. The finite element analysis uses matrices of equations wherein each equation corresponds to the node of a finite element. The use of equations to simulate symmetry allows for the use of the one-quarter plate as the model to be analyzed. This simplifies the analysis compared to an analysis of all of the finite elements of an entire plate. Heat transfer equations are used in the matrix of finite element equations to describe the heat transfer conditions at the nodes. Such equations include those which describe zero heat transfer, and conductive heat transfer. In this analysis, a boundary condition of 5.6 watts of heat power was applied to the active region of the bipolar plate assembly. 5.6 watts corresponds to one-quarter of the heat power which may be produced when a stack with an active area of about 158 cm² is operated with a total current of about 60 amps. This corresponds to a current density of about 0.38 amps/cm². In the analysis a constant temperature of 160° C. was applied to one of the longitudinal side faces of the bipolar plate assembly. The 160° C. temperature is the temperature which a heat exchanger may be expected to maintain the edge of a bipolar plate when the stack current is at 0.38 amps/cm², which is about the maximum current density at which the MEA is run to achieve long stack life. Other maximum current density may be less than 0.38 amps such as 0.3 amps/cm² or 0.2 amps/cm². Also the maximum current density applied to achieve long stack life may be greater than 0.38 amps/cm² such as 0.4 amps/cm² or 0.5 amps/cm². The surfaces of the quarter plate which do not have boundary conditions applied in the analysis are assumed by the analysis to be adiabatic. As depicted in FIGS. 58 and 59, the analysis predicts a 5.72 K temperature variation from the midplane of the bipolar plate assembly to its longitudinal side face.

A one-quarter plate computational thermal analysis of the bipolar plate assembly illustrated in FIGS. 46-51 was also conducted to determine the temperature distribution under thermal-loading conditions for this embodiment. In this analysis, 5.6 watts of heat power were applied to the active region of the bipolar plate assembly and a constant temperature of 160° C. was applied to one of the longitudinal side faces of the bipolar plate assembly. As depicted in FIGS. 58 and 59, the analysis predicts a 5.72 K temperature variation from the midplane of the bipolar plate assembly to its longitudinal side face.

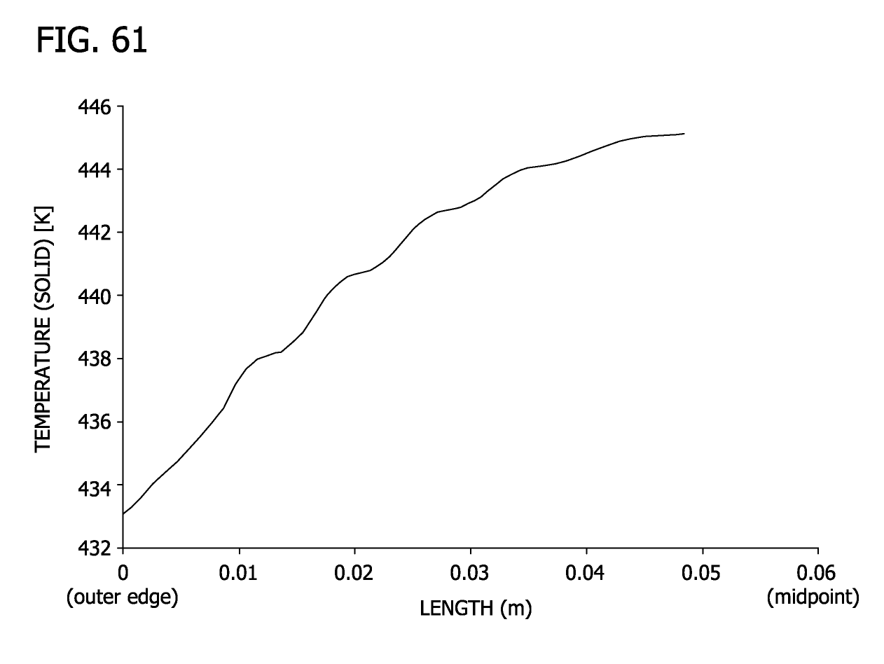

For comparison purposes, a one-quarter plate computational thermal analysis was also conducted on a conventional monolithic bipolar plate (i.e., without an insert member) to determine the temperature distribution under thermal-loading conditions. In this analysis, 5.6 watts of heat power were applied to the active region of the bipolar plate assembly and a constant temperature of 160° C. was applied to one of the longitudinal side faces of the bipolar plate assembly. As depicted in FIGS. 60 and 61, the analysis predicts a 12.25 K temperature variation from the midplane of the bipolar plate assembly to its longitudinal side face.

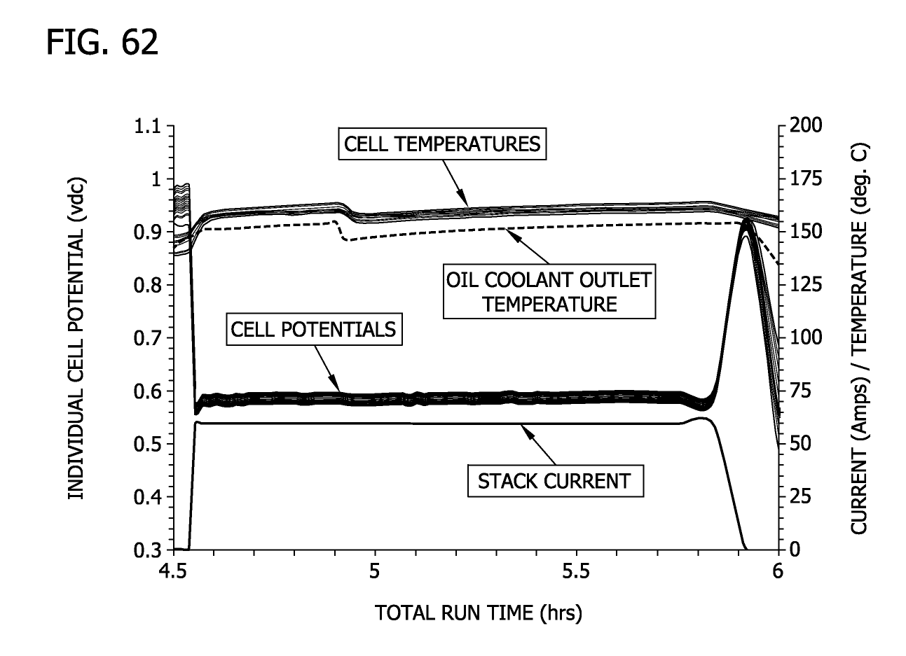

FIG. 62 graphically provides data collected during the operation of a 1.25 kW 36-cell fuel cell stack with external oil cooling having a plurality (i.e., 36) of the bipolar plate assemblies illustrated in FIGS. 1-6. More specifically, FIG. 62 graphically provides the cell temperatures of all 36 bipolar plate assemblies, the outlet temperature of the oil coolant, the cell potentials for all 36 bipolar plate assemblies, and the current of the entire stack between 4.5 hours and 6 hours of operation.

When introducing elements of the present invention or the preferred embodiment(s) thereof, the articles “a”, “an”, the and “said” are intended to mean that there are one or more of the elements. The terms “comprising”, “including” and “having” are intended to be inclusive and mean that there may be additional elements other than the listed elements. Moreover, the use of “top”, “bottom”, “above”, “below” and variations of these terms is made for convenience, and does not require any particular orientation of the components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A bipolar plate assembly comprising a first material and a second material, the second material having an in-plane thermal conductivity greater than the first material, the second material having a width and a thickness, a ratio of the width to the thickness of the second material being between 50 and 400.

2. The bipolar plate assembly as set forth in claim 1 wherein the ratio of the width to the thickness of the second material is between 190 and 380.

3. The bipolar plate assembly as set forth in claim 1 wherein the in-plane thermal conductivity of the second material is greater than 100 W/mK.

4. The bipolar plate assembly as set forth in claim 3 wherein the in-plane thermal conductivity of the second material is greater than 300 W/mK.

5. The bipolar plate assembly as set forth in claim 4 wherein the in-plane thermal conductivity of the second material is greater than 500 W/mK.

6. The bipolar plate assembly as set forth in claim 1 wherein the in-plane thermal conductivity of the first material is less than 60 W/mK.

7. The bipolar plate assembly as set forth in claim 6 wherein the in-plane thermal conductivity of the first material is less than 30 W/mK.

8. A bipolar plate assembly having a longitudinal axis and a transverse axis, the assembly comprising:
at least one bipolar plate being formed from a first material; and
at least one insert member being formed from a second material, the second material having an in-plane thermal conductivity greater than the first material and adapted to conduct heat away from the longitudinal axis of the bipolar plate assembly.

9. The bipolar plate assembly as set forth in claim 8 wherein the at least one bipolar plate comprises a first bipolar plate and a second bipolar plate, the at least one insert member being disposed between the first and second bipolar plates.

10. The bipolar plate assembly as set forth in claim 9 further comprising a front face, a back face, a pair of longitudinal side faces, and a pair of lateral side faces.

11. The bipolar plate assembly as set forth in claim 10 wherein the first bipolar plate defines the front face and the second bipolar plate defines the back face.

12. The bipolar plate assembly as set forth in claim 11 wherein the at least one insert member defines at least a portion of one of the longitudinal side faces, the insert member being adapted to conduct heat towards the longitudinal side face defined at least in part by the at least one insert member.

13. The bipolar plate assembly as set forth in claim 12 wherein the at least one insert member defines at least a portion of both of the longitudinal side faces, the insert member being adapted to conduct heat toward both of the longitudinal side faces.

14. The bipolar plate assembly as set forth in claim 8 wherein the at least one bipolar plate is molded from the first material.

15. The bipolar plate assembly as set forth in claim 8 wherein the at least one insert member is die cut from the second material.

16. A bipolar plate assembly comprising:
at least one bipolar plate being formed from a first material, the first material having a thermal conductivity less than 60 W/mK; and
at least one insert member being formed from a second material, the second material having an in-plane thermal conductivity greater than greater than 100 W/mK.

17. The bipolar plate assembly as set forth in claim 16 wherein the in-plane thermal conductivity of the first material is less than 30 W/mK and the in-plane thermal conductivity of the second material is greater than 300 W/mK.

18. The bipolar plate assembly as set forth in claim 17 wherein the in-plane thermal conductivity of the first material is less than 10 W/mK and the in-plane thermal conductivity of the second material is greater than 500 W/mK.

19. The bipolar plate assembly as set forth in claim 16 wherein the at least one bipolar plate comprises a first bipolar plate and a second bipolar plate, the at least one insert member being disposed between the first and second bipolar plates.

20. The bipolar plate assembly as set forth in claim 19 wherein the first ands second bipolar plates cooperatively define an interior chamber, the at least one insert member being disposed within the interior chamber.
